(19) United States
(12) Patent Application Publication
(10) Pub. No.: US 2010/0047904 A1
(43) Pub. Date: Feb. 25, 2010

(54) MATERIALS, METHODS AND SYSTEMS FOR PURIFICATION AND/OR SEPARATION

(76) Inventors: Gareth Michael Forde, Victoria (AU); Michael Kobina Danquah, Victoria (AU)

Correspondence Address: JONES DAY, 222 EAST 41ST ST, NEW YORK, NY, 10017, US

(21) Appl. No.: 12/312,536

(22) PCT Filed: Nov. 19, 2007
(86) PCT No.: PCT/AU2007/001778

§ 371 Date: Oct. 28, 2009

(30) Foreign Application Priority Data
Nov. 17, 2006 (AU) 2006906425
Nov. 20, 2006 (AU) 2006906452

(51) Int. Cl. C12N 15/63; B01J 20/26; B01J 37/30; B01J 20/34

(52) U.S. Cl. 435/320.1; 502/402; 502/11; 502/20

(57) ABSTRACT

Materials, methods and systems are provided for the purification, filtration and/or separation of certain molecules such as certain size biomolecules. Certain embodiments relate to supports containing at least one polymethacrylate polymer engineered to have certain pore diameters and other properties, and which can be functionally adapted to for certain purifications, filtrations and/or separations.

### CROSS-REFERENCE TO RELATED APPLICATIONS

The present application is related to the following: Australia provisional application 2006906425, filed 17 Nov. 2006, entitled, Chromatography Method; and Australia provisional application 2006906452, filed 20 Nov. 2006, entitled, Chromatography Method (2). The entire content of each of these applications is hereby incorporated by reference.

### FIELD

The present inventions relate to materials, methods and systems for the purification, filtration and/or separation of certain molecules such as biomolecules, plasmid DNA. More particularly, the inventions relate to supports containing at least one polymethacrylate polymer engineered to have certain pore diameters and other properties, and which can be can be functionally adapted to for certain purifications, filtrations and/or separations.

### BACKGROUND

Orthodox particulate stationary phases for chromatographic separation are prepared by packing micrometer sized porous particles into a column. Separation of biomolecules occurs on the internal surface area of the particles which requires diffusion of molecules into the pores; therefore, the rate of separation is diffusion limited, hence the rate can be increased only at the expense of lower separation quality. The purification of certain size and/or large biomolecules such as plasmid DNA (pDNA) is “weighed-down” or challenged by the performance of conventional chromatographic supports with small particle pore diameters. Most of these chromatographic supports are designed to have high adsorption capacities for proteins with pore diameters less than 5 nm (see, for example, Tyn, M. and T. Gusek, 1990). In columns packed with such supports, pDNA with a size greater than 100 nm adsorbs predominantly on the outer surface of the particles. Consequently, binding capacities are in the order of tenths of mg pDNA/mL support compared to 200 mg/mL reported for proteins (for example, Shamlou, P. A., 1990). Also, for example, Ghose, S. et al., 2003. observed from confocal microscopy that about 81% of the internal surface area of a conventional support with a pore diameter of 80 nm was unutilised when applied to plasmid DNA purification. Further, relatively low flow rates together with low capacities result in low productivities and low time yields. Additionally, traditional adsorbents and continuous stationary phases have high pressure drops across the adsorbent beds and are more susceptible to blockage and fouling.

Continuous stationary phases are essential tools for bioseparation and biotransformation, and are the adsorbent materials of choice for the purification of biomolecules. These materials are characterised by low mass transfer resistance. Thus, all applications involving large molecules exhibit, in principle, better performance compared to conventional particulate stationary phases (i.e. beaded media).

A monolith is a continuous phase support consisting of a single piece of a highly porous organic or inorganic solid material. The main feature of such a support material is that all the mobile phase is forced to flow through its large pores (for example, Jungbauer, A. and R. Hahn, 2004). As a consequence, mass transport is steered by convection; reducing the long diffusion time required by particle-based supports. Chromatographic separation process on monoliths is therefore virtually not diffusion-limited. Further, the large pores of these monoliths allows for the penetration of pDNA molecules to the internal surface area, thereby facilitating the accessibility of pDNA molecules by the internal functional sites of the resin and, in turn, minimising pressure drop (for example, Strancar, A. et al., 2002a). However, there exists generally, a “trade-off” between pressure drop and binding capacity as increasing pore size decreases binding capacity (decreasing surface area) and decreasing pore size increases pressure drop.

Different types of monolithic supports currently available are cryogels from polyacrylamide (for example, Arvidsson, P. et al., 2003; Kumar, et al., 2003), emulsion-derived monoliths (Mercier, A. et al., 2000), polymethacrylate based polymers synthesised by free radical polymerisation induced thermally (for example, Mercier, A. et al., 2000; Josic, D. et al., 1999; Svec, F. et al., 1999; Zou, H. et al., 2001; Stracar, A. et al., 2002b; Xie, S. et al., 2002) or by radiation (for example, Graselli, M. et al., 2001), silica columns manufactured as single blocks by a sol-gel process (for example, Minakuchi, H. et al., 1996; Ishizuka, N. et al., 1998), silica xerogels (for example, Fields, S. M. et al., 1996), monoliths prepared from compressed polyacrylamide gels (for example, Hjerten, S. et al., 1988; Hjerten, S. et al., 1992), polymer monoliths prepared through metathesis (for example, Mayr, B. et al., 2001), monoliths prepared from carbon microspheres (for example, Liang, C. et al., 2003; Yamamoto, T., et al., 2002), carbon monoliths (for example, Liang, C. et al., 2003), cellulose-based monoliths (for example, Noel, R. et al., 1993), superporous agarose gel (Gustavsson, P. E. et al., 2001), poly vinyl alcohol (for example, Lozinsky, V. I. et al., 1998), polyacrylamide-coated ceramics (for example, Martin del Valle, E. et al., 2003) and rolled woven fabrics (for example, Hamaker, K. et al., 1999).

The present applicants have found that certain polymethacrylate monolithic supports can be engineered to have large pore diameters and/or other properties, such that there is no significant, or substantially significant, impedance to convective mass transport and other beneficial properties. Further, they have found that such supports can be easily modified, or modified, by functionalising with an anion-exchange, hydrophobic interaction or affinity ligand depending upon the type of purification technique to be employed. Some of these supports have been shown to be resistant to pH, are typically non-toxic, and/or relatively inexpensive to synthesise. Moreover, in certain embodiments, the flexibility and ease by which they may be “tailored” to provide for certain pore and surface characteristics suitable for a particular target molecule through alteration in synthesis conditions, makes them an attractive alternative to the currently available supports mentioned above. Furthermore, certain supports can be engineered to have provided filtration of certain size biomolecules and other products.

### SUMMARY

Certain embodiments disclosed methods for producing polymer adsorbents with a controllable pore size. Certain embodiments disclosed polymer adsorbents with a controllable pore size. In some aspect, the pore size of the polymer adsorbents may be monodispersed. In some aspect, the pore size of the polymer adsorbents may be near-Gaussian distribution. In some aspects, the pore size of the polymer adsorbents may be such that the majority of pores lie close to the modal pore diameter. In some aspects, the pore size may have an average pore diameter ranging from 2200 nm-100 nm. Other pore diameter ranges are also contemplated, for example, wherein the support is provided with pores having an average diameter of between about 150 nm and 1850 nm. In some aspects, the polymer adsorbent may be monolithic supports containing at least one polymethacrylate.

In certain embodiments, the pore size of the polymer adsorbents may be controllable using the synthesis methods disclosed herein. In some aspects, the temperature of polymerization is kept constant by pre-polermization heat expulsion due to initiator decomposition. In some aspects, the content and/or ratios of the initiator, monomer, porogen (liquid and/or solid and/or gas) may be selected to yield particular physical characteristics.

In certain embodiments, a porous polymethacrylate monolithic support is provided for use in chromatography, wherein said support comprises a polymethacrylate comprising a polymer of one or more methacrylate monomer types, functionalised with one or more chromatographically functional groups, and wherein said support is provided with pores having an average diameter of between about 100 nm and 2200 nm and which is further characterised in that any pores present in the support having a diameter less than 50 nm represent less than 6% of the differential pore volume (mL/g) of said support. Other pore diameter ranges are also contemplated, for example, wherein the support is provided with pores having an average diameter of between about 150 nm and 1850 nm.

In some aspects, the polymethacrylate comprises a polymer of two methacrylate monomer types; one of which is functionalised with said one or more chromatographically functional groups, and the other of which is present as a crosslinking agent.

In some aspects, the polymethacrylate comprises a polymer of glycidyl methacrylate (GMA) functionalised with said one or more chromatographically functional groups (e.g. 2-chloro-N,N-diethylethylamine hydrochloride (DEAE-Cl) for anion exchange chromatography), and ethylene glycol dimethacrylate (EDMA) present as a crosslinking agent.

In certain embodiments, a porous polymethacrylate monolithic support is provided for use in chromatography, wherein said support comprises a polymethacrylate comprising a polymer of one or more methacrylate monomer types, functionalised with one or more chromatographically functional groups, and wherein said support is provided with pores having an average diameter of between about 100 nm and 2200 nm, where for plasmid DNA with a hydrodynamic diameter of ˜200 nm, the more preferred median pore size is 350-375 nm which results in a binding capacity of 12.5 mg/ml and where for plasmid DNA with a hydrodynamic diameter of ˜600 nm, the more preferred median pore size is 750 nm which results in a binding capacity of 17.8 mg DNA/ml adsorbent, and where the target is bacteria with a hydrodynamic diameter of ˜1000 nm, the preferred median pore size is 2000 nm. Other pore diameter ranges are also contemplated, for example, wherein the support is provided with pores having an average diameter of between about 150 nm and 1850 nm.

In certain embodiments, the pores present in the support having a diameter less than about 50 nm represent less than about 6% of the total pore volume (mL/g) of said support and that adsorbent support with median pore sizes between about 150 nm and 1850 nm, the pores present in the support having a diameter outside of this range represent less than 5% of the total pore volume (mL/g) of said support.

In some aspects, the polymethacrylate comprises a polymer of at least two methacrylate monomer types; one of which is functionalised with said one or more chromatographically functional groups, and the other of which is present as a crosslinking agent, or combinations thereof.

In some aspects, the polymethacrylate comprises a polymer of glycidyl methacrylate (GMA) functionalised with said one or more chromatographically functional groups (e.g. 2-chloro-N,N-diethylethylamine hydrochloride (DEAE-Cl) for anion exchange chromatography), and ethylene glycol dimethacrylate EDMA) present as a crosslinking agent.

Certain embodiments disclosed may be adapted for the purification or isolation of biomolecules such as, but not limited to, polynucleotide molecules, oligonucleotide molecules including antisense olignucleotide molecules such as antisense RNA and other oligonucleotide molecules that are inhibitory of gene function (i.e. “gene-silencing” agents) such as small interfering RNA (siRNA), polypeptides including proteinaceous infective agents such as prions, and viruses. Preferably, in some aspects the embodiments disclosed are adapted for the purification or isolation of biomolecules with a hydrodynamic diameter within the range of about 100-2200 nm, and more preferably, polynucleotide molecules (e.g. double-stranded DNA, plasmid DNA and genomic DNA, and double-stranded RNA) and viruses of such size. In some aspects, the embodiments disclosed are adapted for the purification or isolation of biomolecules with a hydrodynamic diameter within the range of about 100-2200 nm. In some aspects, the embodiments disclosed are adapted for the purification or isolation of polynucleotide molecules (e.g., but not limited to, double-stranded DNA, plasmid DNA and genomic DNA, and double-stranded RNA) and viruses of such size. In more preferred embodiments, for the purification of a 200 nm. In some aspects, the embodiments disclosed are adapted for the purification or isolation of polynucleotide molecules, viruses, over a number of range sizes as disclosed herein. In some aspects, the embodiments disclosed are adapted for the purification or isolation of certain size substances as disclosed herein. Other pore diameter ranges are also contemplated, for example, wherein the support is provided with pores having an average diameter of between about 150 nm and 1850 nm.

In some aspects, chromatographic columns and chromatography systems are provided comprising a polymethacrylate monolithic support according to the above-mentioned embodiments. In some embodiments, chromatographic columns comprising at least one polymethacrylate support as disclosed herein are provided.

In certain embodiments, a method for isolating or purifying a target molecule (e.g. a biomolecule) are provided, said method comprising contacting a sample containing, or suspected of containing, said molecule with a polymethacrylate monolithic support under conditions suitable for the molecule to bind (e.g. adsorb and/or absorb) to said support, and thereafter removing the bound molecule from said support. In certain embodiments, methods for isolating and/or purifying at least one target molecule are provided, said methods comprising contacting the substance containing, or suspected of containing, said at least one target molecule with a support containing at least one polymethacrylate support under conditions suitable for the at least one target molecule to bind to said support, and thereafter removing the bound molecule from said support containing at least one polymethacrylate support. The molecules may bind to the support containing at least one polymethacrylate support by various means, including, but not limited to adsorption, absorption or combinations thereof.

In certain embodiments, the removal (if desired) of the bound molecules from the support containing at least one polymethacrylate support may be accomplished in a number of ways as disclosed herein. For example, in some embodiments a typically way is to remove of the bound molecule from the polymethacrylate monolithic support comprises eluting the molecule with a suitable elution buffer.

In certain embodiments, a kit comprising a polymethacylate monolithic support according to certain other embodiments or a column according to certain other embodiments together with one or more suitable elution buffers. In certain embodiments, a kit comprising at least one polymethacylate monolithic support according to certain embodiments or a column according to certain embodiments together with one or more suitable elution buffers.

Certain embodiments disclosed herein may include the materials, supports, methods, kits, systems, or combinations thereof.

Certain embodiments provide a support apparatus comprising: a polymer of one or more methacrylate monomers, wherein said one or more monomers comprises one or more functional groups; and pores having an average diameter between about 100 nm and about 2000 nm. In some aspects, the apparatus may have pores having an average diameter between about 320 and about 1150 nm, or between about 150 nm and about 1850 nm. In some aspects, the apparatus may have at least one monomer comprising one or more functional groups selected from a group consisting of: butylmethacrylates, glycol methacrylates, methyl 2-methylprop-2-enoate, oxiran-2-ylmethyl 2-methylprop-2-enoate, ethyl methylacrylates, oxydiethylene methacrylates, oxydiethylene methacrylate, N-(4-tolyl)glycine-glycidyl methacrylate, methyl 2-methylprop-2-enoate; octadecyl 2-methylprop-2-enoate, oxiran-2-ylmethyl 2-methylprop-2-enoate, glycidyl methacrylate (GMA), or combinations thereof.

In some aspects, the apparatus may have at least one monomer comprising one or more functional groups such as GMA. In some aspects, the apparatus may have at least one crosslinking agent selected from the group consisting of: butylmethacrylates and trimethacrylates including trimethylolpropane trimethacrylate (TRIM) ethylene glycol dimethacrylate (EDMA), or combinations thereof. In some aspects, the crosslinking agent is EDMA. In some aspects, the apparatus may have one or more monomers comprising one or more functional groups such as GMA; and wherein the crosslinking agent is EDMA. In some aspects, the apparatus may have a functional group selected from a group consisting of: an anion-exchange ligand, cation-exchange ligand, hydrophobic interaction ligand, ion-pairing ligand, affinity ligand, or combinations thereof. In some aspects, the apparatus may have at least one anion-exchange ligand selected from a group consisting of: quaternary ammonium cations, primary, secondary or tertiary amines, and diethylethanolamines such as 2-chloro-N,N-diethylethylamine hydrochloride (DEAE-Cl), or combinations thereof. In some aspects, the apparatus may have at least one cation-exchange ligand selected from a group consisting of: poly-L-lysine (PLL), DEAE-dextran, poly-D-lysine (PDL), poly-ethyleneimine (PEI), polyethylene glycol-poly-L-lysine (PEG-PLL), or combinations thereof. In some aspects, the apparatus may have at least one hydrophobic interaction ligand selected from a group consisting of: alkyl groups having from about 2 to about 10 carbon atoms, such as a butyl, propyl, octyl, or aryl groups such as phenyl, or combinations thereof. In some aspects, the apparatus may have at least one ion-pairing ligand selected from a group consisting of: cationic hydrophobic species such as alkylammonium salts of organic or inorganic acids including tetramethyl, tetraethyl, tetrapropyl and tetrabutyl ammonium acetates, halides, dimethylbutylammonium, dimethylhexylammonium, dimethylcyclohexylammonium and diisopropylammonium acetates, triethylammonium acetate, tetrabutylammonium bromide, or combinations thereof. In some aspects, the apparatus may have at least one affinity ligand selected from a group consisting of: avidinbiotins, carbohydrates, glutathiones, lectins, or specialty ligands including amino acids, immunoglobulins, insoluble proteins, nucleotides, polyamino acids and polynucleotides, including ligands designed to target specific molecular structures or sequences, or combinations thereof. In some aspects, the apparatus may have pores that are unimodal. In some aspects, the apparatus may have pores that are either monodispered or substantially monodispersed.

In some aspects, these pores are interconnected. In some aspects, the apparatus may be a column or disc.

In some aspect, the apparatus may be in a column for gravity flow filtration or gas liquid chromatography. In some aspects, the disc used is for gravity flow filtration or plugs. In some aspects, the apparatus may be used in discs forms having different mean pore diameters and/or functional groups.

In certain embodiments, a method of manufacturing an apparatus, comprising: polymerizing one or more monomers at a temperature between about 50° C. and 70° C.; adding one or more porogens; and optionally adding one or more initiators. In some aspects, the method may further comprising preheating a mixture of said porogen and said initiator prior to combing said mixture to the polymerization. In some aspects, the method may further comprise minimizing heat buildup. In certain embodiments, the methods may further comprising preheating and mixing monomer feeds to just below synthesis temperature before adding to synthesis chamber.

In certain embodiments, methods are provided of purifying or separating or filtrating or isolating a target molecule, comprising: providing an apparatus, comprising a polymer of one or more methacrylate monomers, wherein said one or more monomers comprises one or more functional groups; and pores having an average diameter between about 150 nm and about 1850 nm; applying a sample to said apparatus; eluting said target molecule from said apparatus with an elution buffer; and optionally analysing said target molecule.

In some aspects, the method may be applied to target molecules having a size between about 100 nm and 2000 nm.

In certain embodiments, kits comprising an apparatus are provided, wherein the apparatus comprises a polymer of one or more methacrylate monomers, wherein said one or more monomers comprises one or more functional groups; and pores having an average diameter between about 100 nm and about 2000 nm. In some aspects, the kit may further comprise an elution buffer, a washing buffer and/or a running buffer. In some aspects, the kit may further comprise instructions.

In certain embodiments, methods of reusing or regenerating an apparatus are provided. In certain embodiments, methods of reducing the number of unit operations in a post-clarification plasmid downstream processing are provided.

### DESCRIPTION OF THE FIGURES

FIG. 1 shows Polymerisation reaction between ethylene glycol dimethacrylate (EDMA) and glycidyl methacrylate (GMA). (B) Reaction of 2-chloro-N,N-diethylethylamine hydrochloride functionalisation of epoxy groups on EDMA/GMA polymer, according to certain embodiments.

FIG. 2 shows the dependency of plasmid size on ionic strength of binding buffer. Ionic strength of the binding was increased by increasing concentration of NaCl from 0M→+0.5M→1.0 M. The D[4,3] values obtained are 207 nm, 190 nm and 126 nm for 0M, 0.5M and 1.0 M, respectively, according to certain embodiments. (▴) 0M NaCl, (▪) 0.5M NaCl and (♦) 11.0M NaCl.

FIG. 3 shows the cumulative pore volume and differential pore volume against pore diameter of the monolith composed of 20/20/50/10 GMA/EDMA/cyclohexanol/1-dodecanol using mercury intrusion porosimeter, according to certain embodiments. The plot shows a modal pore diameter of 300 nm existing in the matrix and a total pore volume of 0.95 mL/g.

FIG. 4 shows an SEM image of the adsorbent support composed of 20/20/50/10 GMA/EDMA/cyclohexanol/1-dodecanol, according to certain embodiments. The picture shows large throughpores of the monolith and the network structure of the polymerised feed stock. Picture was obtained at ×20,000 magnification and 15 kV operating voltage.

FIG. 5 shows the effect of polymerisation temperature on the pore size distribution of poly (GMA-co-EDMA) adsorbent support, according to certain embodiments. Polymerisation temperature was increased between 50-70° C. and resulted in a corresponding decrease in pore diameter.

FIG. 6 shows the results of an anion-exchange chromatography purification run of pUC19 pDNA, according to certain embodiments.

FIG. 7 shows a calibration curve for different concentrations of supercoiled pDNA and the UV response units (1 RU=5.16_g of sc pDNA). Plasmid samples were obtained from Wizard plus SV Maxiprep. Retention time was found to be independent of plasmid concentration according to the inset.

FIG. 8 shows the anion-exchange chromatographic purification of pUC19 pDNA produced in E. coli DH5, according to certain embodiments.

FIG. 9 shows a monolithic structure made of homogeneous pores having equal diameter with channels not interconnected, according to certain embodiments.

FIG. 10 shows a monolithic structure with non-uniformity in pore structure with channels interconnected, according to certain embodiments.

FIG. 11 shows the dependency of the pressure drop on the media type for a structure with parallel type non-uniformity, according to certain embodiments. For 0≦t≦1 the parallel type non-uniform structure gives a higher pressure drop in comparison to the structure with uniform pore size distribution. For ξ≧1 the parallel type non-uniform structure gives a lower pressure drop in comparison to the structure with uniform pore size distribution.

FIG. 12 shows the effect of cyclohexanol (porogen) concentration in the polymerisation mixture on the surface morphology of methacrylate monolith, according to certain embodiments. Polymerisations were carried out with a constant monomer ratio (EDMA/GMA) of 40/60; polymerisation temperature of 60° C.; AIBN concentration of 1% w/w of monomers. The SEM pictures show increasing pores size with increasing concentration of porogen in the polymerised feedstock. Microscopic analysis was performed at 15 kV.

FIG. 13 shows dependency of average pore size on the presence of 1-dodecanol as a co-porogen for polymers synthesised at different temperatures, according to certain embodiments. Polymerisations were carried out with a constant monomer ratio (EDMA/GMA) of 40/60; polymerisation temperatures of 55° C., 60° C., 65° C., 70° C., 75° C. AIBN concentration of 1% w/w of monomers.

FIG. 14 shows the dependency of pore size distribution on the presence of a carbonate as a solid porogen, according to certain embodiments. Polymerisations were carried out with a constant monomer ratio (EDMA/GMA) of 40/60; polymerisation temperature of 60° C.; AIBN concentration of 1% w/w of monomers.

FIG. 15 shows the effect of the presence of a carbonate as solid porogen on the average pore size of poly (GMA-co-EDMA) monolith for different polymerisation temperature, according to certain embodiments. Polymerisations were carried out with a constant monomer ratio (EDMA/GMA) of 40/60; polymerisation temperatures of 55° C., 65° C., 75° C.; AIBN concentration of 1% w/w of monomers.

FIG. 16 shows the effect of the ratio of monomers (EDMA/GMA) in the polymerisation mixture on the pore and surface morphology of methacrylate monolith, according to certain embodiments. Polymerisations were carried out with monomer ratios of 70/30, 60/40, 50/50 and 40/60; polymerisation temperature of 55° C.; AIBN concentration of 1% w/w of monomers; porogen concentration of 70% v/v feedstock. The SEM pictures show increasing pores size with decreasing monomer ratio in the polymerised feedstock. Microscopic analysis was performed at 15 kV.

FIG. 17 shows the effect of polymerization temperature on the pore and surface morphology of methacrylate monolith, according to certain embodiments. Polymerizations were carried out with monomer ratio of 40/60; polymerization temperatures of 60° C., 65° C., 70° C.; AIBN concentration of 1% w/w of monomers; porogen concentration of 75% v/v feedstock. The SEM pictures show increasing pores size with decreasing polymerization temperature. Microscopic analysis was performed at 15 kV.

FIG. 18 shows the reaction scheme for the decomposition of azobisisobutyronitrile

(AIBN), according to certain embodiments. Reaction shows the formations of free radicals with the evolution of N₂ gas.

FIG. 19 shows the decomposition of 1% w/v of AIBN in cyclohexanol at a maximum set temperature of 100° C., according to certain embodiments. Data show AIBN decomposition temperature of 40-50° C. with a corresponding decrease in the concentration of AIBN owing to the evolution of N₂ gas.

FIG. 20 shows the dependency of pore size distribution on AIBN concentration, according to certain embodiments. Polymerisations were carried out with monomer ratio of 40/60; polymerisation temperature of 60° C.; AIBN concentration of 0.5% w/w, 1.0% w/w and 1.5% w/w of monomers; porogen concentration of 75% v/v feedstock.

FIG. 21 shows the dependence of the measured pressure drop on flow rate and length (volume at constant diameter) of the monolithic layer having an average pore diameter of 570 nm, according to certain embodiments. Pressure drop increases with increasing flow rate and increasing length of the monolithic layer.

FIG. 22 shows the dependency of measured pressure drop on flow rate for different monoliths polymerised at different temperatures 60° C., 65° C. and 70° C., according to certain embodiments. Polymerisations were carried out with monomer ratio of 40/60; AIBN concentration of 1.0% w/w of monomers; porogen concentration of 65% v/v feedstock. Generally, an increase in pressure drop was observed with increasing polymerisation temperature.

FIG. 23 shows the dependency of measured pressure drop on flow rate for different monoliths polymerised at different temperatures 60° C., 65° C. and 70° C., according to certain embodiments. Polymerisations were carried out with monomer ratio of 40/60; AIBN concentration of 1.0% w/w of monomers; porogen concentration of 65% v/v feedstock. Generally, an increase in pressure drop was observed with increasing polymerisation temperature.

FIG. 24 shows the nitrogen adsorption-desorption isotherm at 77 K for the methacrylate monolithic polymer matrix, according to certain embodiments. BET surface area of 12 m²/g was obtained from this isotherm.

FIG. 25 the effect of ionic strength of loading buffer on binding, retention and elution of pUC19 pDNA from clarified lysate as well as reduction of copurification of RNA and protein contaminants, according to certain embodiments. Stationary phase: DEAE-Cl functionalised methacrylate monolith with active group density 2.25 mmol DEAE-Cl/g resin and modal pore size 350-375 nm. Mobile phase: 25 mM Tris-HCl, 2 mM EDTA, pH=8.1 containing 0.2 M [FIG. 25A], 0.4 [FIG. 25B], and 0.6 M [FIG. 25C] NaCl. Sample: 20 μL of cleared cell lysate. Flow rate; 1 mL/min. Final plasmid obtained is a pure SC pDNA.

FIG. 26 shows results from EtBr-AGE of pDNA fraction from final chromatographic purification with mobile phase 25 mM Tris-HCl, 2 mM EDTA, 0.6 M NaCl, pH=8.1, according to certain embodiments. Analysis was performed using 1% agarose in TAE×1 buffer, 3 μg/ml EtBr at 66 V for 2 hours. Lane M is 1 kbp DNA ladder; lane 1 represents supercoiled pDNA fraction and lane 2 shows band for linear form obtained from EcoRI cleavage at the sequence GAATTC of the final plasmid. Gel picture reveals no band for contaminants.

FIG. 27 shows an image of an SDS-PAGE gel for final plasmid sample obtained form DEAE-Cl functionalised monolithic purification, according to certain embodiments. Analysis was performed using BIORAD pre-cast poly-acrylamide gel in TSG (Tris-SDS-Glycine) buffer at 130 V for 90 mins and stained with a coomassie blue solution. Lane M represents a pre-stained protein marker; lanes 1, 2, 3, 4 and 5 represent wells loaded with different concentrations pDNA (25.8 μg/mL, 20.3 μg/mL, 15.8 μg/mL, 10.2 μg/mL and 5.4 μg/mL respectively). Gel picture reveals no band for protein in the samples.

FIG. 28 shows the temperature distribution profiles in the radial direction along the length of the 80 mL monolith for bulk polymerisation, according to certain embodiments. Radial points investigated are the centre, 6 mm and 12 mm positions. Figure shows the highest temperature gradient of 55 C established at the centre.

FIG. 29 shows the pore size distribution of samples sliced from the different radial positions (centre, 6 mm and 12 mm) of the 80 mL poly(GMA-co-EDMA) monolith synthesised via bulk polymerisation, according to certain embodiments. The different portions of the monolith display different pore size distributions, thereby rendering the entire pore structure non-uniform.

FIG. 30 shows SEM pictures of the 80 mL monolithic polymer synthesized via bulk polymerisation, according to certain embodiments. Pictures A, B and C show the micrographs of samples sliced from the different radial positions; centre, 6 mm and 12 mm respectively. Pictures display the heterogeneous nature of the pore system.

FIG. 31 shows a comparison of experimentally measured temperature distributions at the centre of the mould during bulk polymerisation of 80 mL monolith at different water bath temperatures; 65° C., 70° C. and 75° C., according to certain embodiments. Maximum temperature gradient increases with increasing polymerisation temperature.

FIG. 32 shows the temperature distribution profiles in the radial direction along the length of the 80 mL monolith synthesized via heat expulsion and bulk polymerisation, according to certain embodiments. Radial points investigated are the centre, 6 mm and 12 mm positions. Figure shows the highest temperature gradient of 8.5° C. established at the centre.

FIG. 33 shows the pore size distribution of samples sliced from the different radial positions (centre, 6 mm and 12 mm) of the 80 mL poly(GMA-co-EDMA) monolith, according to certain embodiments. The different portions of the monolith display pore size distributions with improved uniformity. An identical modal pore diameter of ˜400 nm is revealed by the different samples.

FIG. 34 shows SEM pictures of the 80 mL monolithic polymer synthesized via heat expulsion and bulk polymerisation, according to certain embodiments. Pictures A, B and C show the micrographs of samples sliced from the different radial positions; centre, 6 mm and 12 mm respectively. Pictures display an improvement in the uniformity of the pore structure.

FIG. 35 shows temperature distribution profiles in the radial direction along the length of the 80 mL monolith synthesized via heat expulsion and gradual addition polymerisation, according to certain embodiments. Radial points investigated are the centre, 6 mm and 12 mm positions. Figure shows the highest temperature gradient of only 4.3° C. established at the centre.

FIG. 36 shows pore size distribution of samples sliced from the different radial positions (centre, 6 mm and 12 mm) of the 80 mL poly(GMA-co-EDMA) monolith, according to certain embodiments. The different portions of the monolith display identical pore size distribution with extra homogeneity. An identical modal pore diameter of ˜400 nm is revealed by the different samples.

FIG. 37 shows the comparison of experimentally measured temperature distributions at the centre of the mould during the 80 mL methacrylate monolith synthesis via heat expulsion and gradual addition polymerisation at different water bath temperatures; 65° C., 70° C. and 75° C., according to certain embodiments. Increasing the polymerisation temperature does not significantly affect the maximum radial temperature gradient.

FIG. 38 shows the average cumulative pore volume and differential pore volume against pore diameter of the methacrylate monolithic polymer using Hg intrusion porosimeter, according to certain embodiments. The plot shows a modal pore diameter of 750 nm existing in the matrix and a total pore volume of 2.20 mL/g.

FIG. 39 shows the pVR1020-PyMSP4/5 molecular size analysis in TE buffer (25 mM Tris-HCl, pH=8) using a zetasizer (Malvern zetasizer, ZEN 3600, UK), according to certain embodiments. A hydrodynamic size of ˜600 nm was obtained.

FIG. 40 shows the dependency of the flow rate on the dynamic binding capacity, according to certain embodiments. Conditions: flow rate, 6 mL/min, 8 mL/min and 10 mL/min; sample, 9.54 μg/mL pVR1020-PyMSP4/5 in a 25 mM Tris-HCl, 2 mM EDTA pH 8; detection, UV at 260 nm.

FIG. 41 shows the effect of the flow rate on resolution for the isolation of pVR1020-PyMSP4/5 from E. coliDH5α-pVR1020-PyMSP4/5 clarified lysate at three different flow rates (6 mL/min, 8 mL/min and 10 mL/min), according to certain embodiments. Mobile phase: 25 mM Tris-HCl, 2 mM EDTA, 0.2 M NaCl, pH 8 (buffer A) and 25 mM Tris-HCl, 2 mM EDTA, 2.0 M NaCl, pH 8 (buffer B). Gradient elution: 0-0.325 M for 102 s and Step elution, 0.325-0.75 M for 78 s. Peaks 1, 2 and 3 represent RNA, proteins and pVR1020-PyMSP4/5 vaccine fractions respectively.

FIG. 42 shows the effect of ionic strength of binding buffer on retention and elution of pVR1020-PyMSP4/5 from E. coliDH5α-pVR1020-PyMSP4/5 clarified lysate, according to certain embodiments. Chromatograms show reduction in the copurification of RNA and protein contaminants with increasing salt concentration. Stationary phase: amino-functionalised methacrylate monolith with active group density 1.49 mmol/g polymer and modal pore size 750 nm. Mobile phase: 25 mM Tris-HCl, 2 mM EDTA, ×NaCl, pH=8. Sample: 30 mL of clarified lysate. Flow rate; 10 mL/min. Gradient elution: 0-0.325 M for 102 s and Step elution, 0.325-0.75 M for 78 s. Peaks 1, 2 and 3 represent RNA, proteins and pVR1020-PyMSP4/5 vaccine fractions respectively.

FIG. 43 shows A) Results from EtBr agarose gel electrophoresis of pVR1020-PyMSP4/5 fraction from the final chromatographic purification with binding buffer 25 mM Tris-HCl, 2 mM EDTA, 1.0 M NaCl, pH=8, according to certain embodiments. Analysis was performed using 1% agarose in TAE×1 buffer, 3 μg/ml EtBr at 66 V for 2 hours. Lane M is 1 kbp DNA ladder; lane 1 represents supercoiled pDNA fraction and lane 2 shows band for linear form obtained from BamHI cleavage at the sequence -G-G-A-T-C-C- of the final plasmid vaccine. Gel picture reveals no band for RNA or gDNA contaminants. B) SDS PAGE analysis to determine the protein content of the plasmid vaccine sample. Analysis was performed using BIORAD pre-cast poly-acrylamide gel in TSG (Tris-SDS-Glycine) buffer at 130 V for 90 mins and stained with a coomassie blue solution. Lane M represents a pre-stained protein marker; lanes 1 and 2 represent wells loaded with 28.4 μg/mL and 23.5 μg/mL of pVR1020-PyMSP4/5 vaccine samples. Picture reveals no protein bands.

FIG. 44 shows the effect of NaCl concentration on pVR1020-PyMSP4/5 vaccine endotoxin level, according to certain embodiments. The analysis shows a gradual decrease in endotoxin level from 3.21 EU/mg pDNA to 0.28 EU/mg pVR1020-PyMSP4/5 for 0 M and 1.0 M NaCl respectively.

### DETAILED DESCRIPTION

In certain embodiments, supports with at least one polymethacrylate support having a portions of the pore diameters within certain ranges results support with a desirable level of impedance in convective mass transport. When modified by functionalising with at least one chromatographically functional group, such polymethacrylate supports can be functionally adapted to a specific type of purification. The flexibility and ease by which they can be tailored to provide for certain pore and surface characteristics suitable for binding a particular target molecule through alteration in synthesis conditions, makes them an attractive alternative to the currently available supports mentioned above.

Further, these supports have shown to be resistant to pH, are typically non-toxic, and are also relatively inexpensive to synthesise. In certain embodiments, the present applicant has found, among other things, that polymethacrylate monolithic supports having large pore diameters provide no significant impedance, or substantially less impedance, to convective mass transport. As used herein monolith supports are chromatographic supports of porous material through which a sample is mainly transported by convection. In certain aspects, the monolithic support may be made from a single piece. In certain aspects, the monolithic supports may also be made of at least 1, 2, 3, 4, 5 or 6 pieces. In certain aspects, the monolithic supports may be made from multiply pieces. As a consequence, certain monoliths support embodiments disclosed enable fast separations which make them attractive for purification of macromolecules like proteins or DNA. As disclosed herein the methacrylate-based monolithic column embodiments are able to perform high-resolution separations of large amounts of targeted entities.

Certain embodiments disclose a cost effective non-toxic scalable technique for rapid pDNA production employing a methacrylate monolithic adsorbent. The synthesis and characterization of the polymeric resin with a pore diameter distribution and structure tailored for pDNA binding and retention are disclosed herein. The use of DEAE-Cl functionalised methacrylate resin for single-stage fast anion exchange purification is disclosed herein as well as the effect of ionic strength of binding buffer on the co-purification of contaminants.

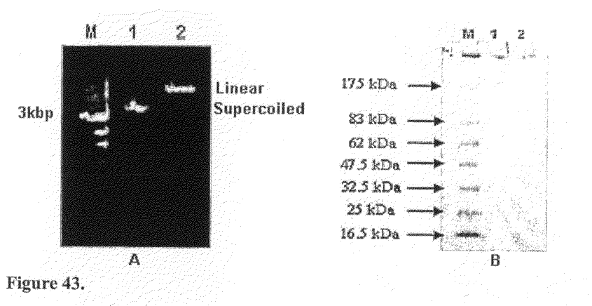

Certain embodiments disclosed a cost effective, non-toxic and scalable technique for the rapid isolation of a pDNA encoding PyMSP4/5, a homologue of P. falciparum merozoite surface protein 4 (MSP4) and 5 (MSP5) in rodent malaria species P. yoelii. MSP4 and MSP5 are two glycosylphosphatidylinositol (GPI)-anchored integral membrane proteins that are potential components of a subunit vaccine against malaria. Their single homologues (MSP4/5) in rodent malaria species have structural features similar to both MSP4 and MSP5, and have shown to be highly effective at protecting mice against lethal challenge following immunization with recombinant protein expressed in E. coli. Immunisation with DNA vaccines encoding MSP4/5 provided protection against P. chabaudi blood stage infection, but not in a more stringent challenge model of P. yoelii. Both MSP4 and MSP5 are selected by Malaria Vaccine Initiatives as potential vaccine candidates for pre-clinical development and manufacture (http://www.malariavaccine.org/ab-current_projects.htm). Their potential as two components of a multistage malaria vaccine based on DNA immunization is also being investigated. We isolated pVR1020-PyMSP4/5 using the methacrylate monolithic adsorbent from E. coliDH5α-pVR1020-PyMSP4/5 lysate in only 3 min elution. The synthesis and characterization of the polymeric resin are presented. The possibility of amino-functionalised methacrylate monolith for a single-stage anion-exchange purification of the plasmid vaccine is investigated with the view of enabling reduced number of unit operations in the downstream process, thus improving vaccine recovery and productivity whilst maintaining plasmid integrity (FIG. 43). Comparison between the nature and characteristics of the final purified malaria vaccine and that of regulatory standards is also presented.

Certain of the disclosed embodiments related methods of and uses for polymerized monomers glycidyl methacrylate-ethylene dimethacrylate as a support for separation, purification, isolation, and/or filtering: where it is possible to control accurately the porous properties of moulded macroporous materials over certain specified ranges. These ranges may vary. Furthermore, these specified ranges may be achieved over broad range of pore sizes. The disclosed methods of producing certain support embodiments is achieved by controlling the reaction temperature, the composition of pore-forming solvent, the content of monomers in the polymerization mixture and the concentration of initiator, or combinations thereof. In certain aspects, the polymerisation temperature may be used to adjust the pore size distribution. In certain aspects, increasing the concentration of a poor solvent such as 1-dodecanol in a bi-porogen system may be used to produce polymers with larger specified pore sizes. In certain aspects, an increase in the content of cross-linking monomer may be used to decrease the pore size to a specified range. In certain aspects, various combinations of these variables may be used to optimize the physical properties of the disclosed methacrylate support materials to obtain the desired pore size, shape and/or permeability.

Using certain embodiments, supports may be produced and used that are scalable and commercially-viable for direct capture of pDNA molecule on the disclosed methacrylate monolithic sorbents. Furthermore, these embodiments of the methacrylate resin showed suitable pore and surface properties for binding and retention of the pDNA molecule. The final product obtained after about 5 minutes purification employing certain resins embodiments disclosed was a SC pDNA with no RNA or protein contamination. The sorbent displays the potential to reduce the number of unit operations required to capture pharmaceutical grade pDNA from greater than three to one-stage purification. These procedures can be used at a commercial level as it is economically favorable and cGMP compatible.

Certain embodiments disclose large-volume methacrylate monoliths with homogeneous pore structures produced when the heat of polymerisation is effectively controlled. The heat expulsion technique coupled with the gradual addition approach provide products with excellent functional properties, as it allows the preparation of monoliths of many size that cannot be otherwise obtained. These techniques, combined with the ability to functionalize the monolithic polymers, allow the production of preparative-scale chromatographic columns. In addition, the slow ascendant growth of the monolith that occurs as a result of the gradual addition provides a platform to produce more advanced mould shape conforming materials. Certain embodiments provide commercially viable processes to manufacture a plasmid-based malaria vaccine. pDNA is a large molecule and has properties that are similar to those of its contaminants. This, coupled with the low initial concentration of plasmid in the host cell, create challenges that require detailed process engineering design to establish reproducible manufacturing methodologies that comply with cGMP. The embodiments disclosed herein provide commercially viable techniques for the rapid isolation of a pDNA malaria vaccine using, for example, a 40.0 mL methacrylate monolithic stationary phase. Characterization of the methacrylate polymer embodiments shows suitable pore properties for high retention of the pDNA vaccine molecules. For example, the final vaccine product obtained after about 3 minutes elution was a supercoiled pDNA vaccine molecule with gDNA, RNA, protein and endotoxin levels that met regulatory standards for vaccine delivery. The polymer embodiments may be used to reduce the number of unit operations in post-clarification plasmid downstream processing from greater than three to a single-stage purification. These disclosed techniques provide ways to produce plasmid-based malaria vaccine as downstream processes can now be carried out effectively and efficiently to ultimately enhance the productivity of large-scale pDNA vaccine manufacture.

In certain embodiments, the monolithic supports containing at least one polymethacrylate will have certain KPIs, or combinations thereof. In some aspects, the supports will have high biomolecule binding capacities. For example, where the target biomolecule has a hydrodynamic diameter in the range of 20-1000 nm and an average of ˜200 nm, the more preferred median pore size is 350-375 nm which results in a binding capacity of 12.5 mg biomolecule/ml with a 10% dynamic breakthrough at 11 mg DNA/ml adsorbent and where the target biomolecule has a hydrodynamic diameter of 200-1100 and an average of ˜600 nm, the more preferred median pore size is 750 nm which results in a binding capacity of 17.8 mg biomolecule/ml adsorbent with a 10% dynamic breakthrough at 14.2 mg DNA/ml adsorbent, and where the target has a hydrodynamic diameter of >1100 mm, the preferred median pore size is 2200 nm. In some aspects, the adsorbent support contains a pore volume of meso- (2-50 nm) and micro-pores (<2 nm) that represent less than 6% of the total pore volume. For example, for an adsorbent with a modal pore diameter of 750 nm, the total pore volume of meso- and micro-pores is less than 1.6% of the total pore volume; for a modal pore diameter of 350 nm, the total pore volume of meso- and micro-pores is less than 3.2% of the total pore volume. In some aspects, the reduction in meso- and micro-pores greatly enhances the mass transfer properties resulting in faster adsorption/desorption and reduced co-purification of contaminants which can diffuse into the meso- and micro-pores, particularly in the case of particles with hydrodynamic diameters <50 nm (e.g. DNA fragments and cellular debris) and most particularly for particles with hydrodynamic diameters <10 nm (e.g. endotoxins, protein, RNA, lippopolysaccharides, and other cellular debris). Having less volume for contaminants to diffuse into, rather than being subjected to convective mass transfer, results in higher purity of the target biomolecule, which can be of a purity suitable for clinical use after 1 downstream unit operation using the adsorbent support disclosed herein. For example, Table 10 shows data on plasmid DNA purified from a clarified lysate that has purity suitable for clinical applications. These purity results include: 92.5% supercoiled DNA, gDNA and RNA undetectable by EtBr agarose gel electrophoresis, 0.28±0.11 EU/mg pDNA by LAL assay, and protein 0.26±0.08% by Bradford assay. The product is clear and colourless and there are no visible particulates in the final formulation. In some aspects, reproducible binding capacities between runs where the adsorbent display binding capacities that vary by less than 9% from the original binding capacity for up to 5 runs with saline elution buffer and that upon regeneration of the column (with 400 mL of 25 mM Tris-HCl, 2 mM EDTA, 2 M NaCl, pH=8), the binding capacity has negligible (<1%) variation in the binding and breakthrough capacity. In some aspects, that the dynamic breakthrough capacity is not affected by the liquid flow rate. For example, variation in the dynamic binding capacity at flow rates of 6 mL/min, 8 mL/min and 10 mL/min (variation <3%) vary by amounts within the error margin of the assay to determine the dynamic binding capacity. In some aspects, the adsorbent supports containing at least one polymethacrylate of a given median pore size will display reduced pressure drops compared to multidispersed adsorbent supports of the same median pore size due to the monodispersity of the monolith adsorbent support. For example, pressure drops of less than 1.5 MPa/cm of adsorbent bed at flows of 2.83 cm/min and less than 0.36 MPa/cm of adsorbent bed at flow of 0.34 cm/min can be obtained. In another example, the pressure drop across an adsorbent support (composed of monomer ratio of 40/60; AIBN concentration of 1.0% w/w of monomers; porogen concentration of 65% v/v and polymerised at 60° C., 65° C. or 70° C.) the pressure was found to increase linearly from 0.1-0.6 MPa, 0.2-2.1 MPa and 0.5-3.1 MPa for adsorbent polymerised at 60° C., 65° C. or 70° C. respectively for a flow rate range of 1-8 mL/min.

When modified by functionalising with a chromatographically functional group, such polymethacrylate monolithic supports can be functionally adapted to a specific type of purification, and/or separations. The flexibility and ease by which they can be tailored to provide for certain pore and surface characteristics suitable for binding a particular target molecule through alteration in synthesis conditions, makes them an attractive alternative to the currently available supports mentioned above. Further, these supports have shown to be resistant to pH, are typically non-toxic, and are also relatively inexpensive to synthesise. Certain embodiments provides a porous polymethacrylate monolithic support (or adsorbent support) for use in chromatography, purification, filtration, clarification and concentration, wherein said support comprises a polymethacrylate comprising a polymer of one or more methacrylate monomer types, functionalised with one or more chromatographically functional groups, and wherein said support is provided with pores having a mean diameter of between about 150 nm and 1850 nm and which is further characterised in that any pores present in the support having a diameter outside of this range represent less than 5% of the differential pore volume (mL/g) of said support. Certain embodiments provides a substantially porous support, wherein said support comprises at least one polymethacrylate comprising a polymer of one or more methacrylate monomer types, functionalised with at least one functional group, and wherein said support is provided with pores having a mean diameter of between about 150 nm and 1850 nm and which is further characterised in that any pores present in the support having a diameter outside of this range represent less than 5% of the differential pore volume (mL/g) of said support.

Certain embodiments provide at least one porous, or substantially porous, support for use in purification and/or separation, wherein the at least one support comprises at least one polymethacrylate comprising a polymer of one or more methacrylate monomer types, functionalised with one or more functional groups, and wherein said at least one support is provided with pores having a mean diameter of between about 150 nm and 1850 nm, and which is further characterised in that any pores present in the support having a diameter outside of this range represent less than 5% of the differential pore volume (mL/g) of said support.

Certain embodiments provides a porous monolithic support for use in chromatography, wherein said support comprises at least one polymethacrylate comprising a polymer of one or more methacrylate monomer types, functionalised with at least one functional groups, and wherein said support is provided with pores having a first mean diameter range and a second mean diameter range wherein the second diameter range represents less than 5% of the differential pore volume (mL/g) of said support.

In certain embodiments, the pores of the support have a mean pore diameter of between about 180 nm and 850 nm, 320 nm and 1150 nm, 330 nm and 1420 nm, 430 nm and 1740 nm, or 430 nm and 1820 nm. Also, any pores present in the support having a diameter outside of these respective ranges represent less than 5%, more preferably less than 2% and most preferably less than 1%, of the differential pore volume (mL/g).

With respect to certain embodiments, by the term “chromatographically functional group” or variations such as “chromatographically functional groups”, it is to be understood that this refers to groups provided by the functionalised polymethacrylate polymer which provides the support with the properties or characteristics to facilitate binding (e.g. through adsorption and/or absorption) of a target molecule such as a biomolecule, thereby enabling the purification of that target unit. With respect to certain embodiments, by the term “functional group” or variations such as “functional groups”, it is to be understood that this refers to groups which provides the support with the properties or characteristics to facilitate binding (e.g. through adsorption and/or absorption) of a target entity, thereby enabling the purification or separation of that the targeted entity.

The chromatographically functional group or functional group may comprise for example, but are not limited to, an anion-exchange, cation-exchange, hydrophobic interaction, ion-pairing, affinity ligand, or combinations thereof. Suitable examples of anion exchange ligands include, but are not limited to: quaternary ammonium cations, primary, secondary or tertiary amines, and diethylethanolamines such as 2-chloro-N,N-diethylethylamine hydrochloride (DEAE-Cl), or combinations thereof. Suitable examples of cationic exchange ligands include, but are not limited to, poly-L-lysine (PLL), DEAE-dextran, poly-D-lysine (PDL), poly-ethyleneimine (PEI), polyethylene glycol-poly-L-lysine (PEG-PLL), or combinations thereof. Suitable examples of hydrophobic interaction ligands include, but are not limited to: alkyl groups having from about 2 to about 10 carbon atoms, such as a butyl, propyl, octyl, or aryl groups such as phenyl, or combinations thereof. Suitable examples of ion pairing ligands (e.g. for use in reverse-phase ion-pair chromatography) include, but are not limited to: cationic hydrophobic species such as alkylammonium salts of organic or inorganic acids including tetramethyl, tetraethyl, tetrapropyl and tetrabutyl ammonium acetates, halides, dimethylbutylammonium, dimethylhexylammonium, dimethylcyclohexylammonium and diisopropylammonium acetates, triethylammonium acetate, tetrabutylammonium bromide, or combinations thereof. Suitable examples of affinity ligands may include, but are not limited to: avidinbiotins, carbohydrates, glutathiones, lectins, or specialty ligands including amino acids, immunoglobulins, insoluble proteins, nucleotides, polyamino acids and polynucleotides, including ligands designed to target specific molecular structures or sequences, or combinations thereof.

In certain embodiments, the support will contain at least one polymethacrylate comprising a polymer of at least one methacrylate monomer type wherein the support is functionalised with at least one chromatographically functional group, and at least one crosslinking agent, or combinations thereof. In certain embodiments, the support will contain at least one polymethacrylate comprising a polymer of two or more methacrylate monomer types; one of which is functionalised with at least one chromatographically functional group, and the other of which is present as a crosslinking agent. In certain preferred embodiments, the polymethacrylate comprises a polymer of two methacrylate monomer types; one of which is functionalised with said one or more chromatographically functional groups, and the other of which is present as a crosslinking agent.

For example, suitable methacrylate monomers, able to be functionalised with said one or more chromatographically functional groups, include, but are not limited to: butylmethacrylates, glycol methacrylates, methyl 2-methylprop-2-enoate, oxiran-2-ylmethyl 2-methylprop-2-enoate, ethyl methylacrylates, oxydiethylene methacrylates, oxydiethylene methacrylate, N-(4-tolyl)glycine-glycidyl methacrylate, methyl 2-methylprop-2-enoate; octadecyl 2-methylprop-2-enoate, oxiran-2-ylmethyl 2-methylprop-2-enoate, glycidyl methacrylate, or combinations thereof. (GMA). For example, suitable methacrylate monomers able to act as crosslinking agents, include, but are not limited to: butylmethacrylates and trimethacrylates including trimethylolpropane trimethacrylate (TRIM) ethylene glycol dimethacrylate (EDMA), or combinations thereof.

In certain preferred embodiments, the polymethacrylate comprises a polymer of GMA and EDMA (i.e. GMA-co-EDMA), wherein the GMA is functionalised with said one or more chromatographically functional groups. In certain more preferred embodiments, the polymethacrylate comprises GMA-co-EDMA, wherein the GMA is functionalised with 2-chloro-N,N-diethylethylamine hydrochloride (DEAE-Cl) for anion exchange chromatography. Preferably, the GMA and EDMA is present in the GMA-co-EDMA in an amount ranging from a GMA:EDMA ratio of about 25%:75% (v/v) to 75%: 25% (v/v), but more preferably, about 50%:50% (v/v).

In certain embodiments, the supports disclosed may be adapted for the purification, separation, and/or isolation of entities having a hydrodynamic diameter of from 100 nm to about 2000 nm, 100 nm to 2500 nm, 200 nm to 500 nm, 400 nm to 2000 nm, 400 nm to 1000 nm, 500 nm to 1500 nm, of a size greater than 75 nm, greater than 100 nm, greater than 100 nm, greater than 100 nm, greater than 100 nm, greater than 200 nm, greater than 400 nm, greater than 500 nm, greater than 600 nm, greater than 800 nm, greater than 100 nm, greater than 2000 nm, or greater than 2500 nm. In certain embodiments, the supports disclosed may be adapted for the purification, separation, and/or isolation of biomolecules, particularly those having a hydrodynamic diameter of from 100 nm to about 2000 nm, 100 nm to 2500 nm, 200 nm to 500 nm, 400 nm to 2000 nm, 400 nm to 100 nm, 500 nm to 1500 nm, of a size greater than 75 nm, greater than 100 nm, greater than 100 nm, greater than 100 nm, greater than 2500 nm, greater than 200 nm, greater than 400 nm, greater than 500 nm, greater than 600 nm, greater than 800 nm, greater than 1000 nm, greater than 2000 nm, or greater than 2500 nm. In certain embodiments, the supports disclosed herein may be adapted for the purification or isolation of biomolecules, particularly those having a hydrodynamic diameter of a size greater than 100 nm but, preferably, no larger than about 2000 nm, and more preferably no larger than about 500 nm.

Examples of biomolecules having a size in the range of about 100 nm to 2000 nm include, but are not limited to: polynucleotide molecules, oligonucleotide molecules including antisense olignucleotide molecules such as antisense RNA and other oligonucleotide molecules that are inhibitory of gene function (i.e. “gene-silencing” agents) such as small interfering RNA (siRNA), polypeptides including proteinaceous infective agents such as prions (e.g. the infectious agent for CJD), and infectious agents such as viruses and phage. With regard to viruses (which are typically about between 15 and 350 nm in size), the present invention therefore offers a means for viral filtration. This may be suitable for, for example, removal of viruses (e.g. picornaviruses and retroviruses including human immunodeficiency virus (HIV), hepatitis A virus (HAV) and hepatitis C virus (HCV)) in the processing of veterinary and medical liquid preparations or for water purification purposes. Additionally, the present invention offers a means for the recovery of viruses for environmental or clinical testing, as well as for the preparation of veterinary and medical inocula.

In certain embodiments, the supports disclosed herein are preferably adapted for the purification and/or isolation of polynucleotide molecules such as double-stranded DNA and RNA molecules, and in particular, plasmid DNA (pDNA). In this regards, conventional downstream processing units for preparation of pDNA from fermentation preparations, comprises several unit operations dedicated solely to pDNA isolation from fermentation lysates; such unit operations can be both costly and time consuming. Certain embodiments disclosed offer the substitution of these unit operations with a polymethacrylate monolithic support offering the possibility of faster separation at higher flow rates and through-put than the conventional downstream processing units, with a reduced number of unit operations. For example, a semi-clarified material containing particulates which would normally expected to block a packed bed utilised in the unit operations of the conventional downstream processing units, may be loaded onto a support according to the present invention at low pressure drop. Moreover, pDNA purity and the chemical characteristics of certain embodiments disclosed may be produced to comply with current good manufacture practices (cGMP). The present disclosure therefore offers important applications to the purification of pDNA vaccines for, among other things, veterinary and medical indications.

Certain embodiments disclosed polymethacrylate monolithic supports with pores having a mean diameter of between about 150 nm and 1850 nm. The pore diameter can, however, be readily varied (e.g. to tailor the support for the target molecule) to, for example, but not limited to, provide supports with a mean pore diameter of between about 180 nm and 850 nm, 320 nm and 1150 nm, 330 nm and 1420 nm, 430 nm and 1740 nm, or 430 nm and 1820 nm.

In certain preferred embodiments, the pores of the support are “unimodal” meaning that they comprise of a single, essentially parabolic distribution of pore diameter sizes. Certain embodiments disclosed supports that may be moulded, shaped, divided or stacked to various conformations and/or combinations. For example, the support may be moulded to take the conformation of a column (e.g. the support may be moulded to completely fill a column for gravity flow filtration, or otherwise, may be moulded to line a flexible column for use in gas-liquid chromatography).

Certain embodiments provide a chromatographic column comprising a substantially porous support, wherein said support comprises at least one polymethacrylate comprising a polymer of one or more methacrylate monomer types, functionalised with at least one functional group, and wherein said support is provided with pores having a mean diameter of between about 150 nm and 1850 nm and which is further characterised in that any pores present in the support having a diameter outside of this range represent less than 5% of the differential pore volume (mL/g) of said support. Certain embodiments provide a chromatographic column comprising a substantially porous support, wherein said support comprises at least one polymethacrylate comprising at least one porous, or substantially porous, support for use in purification and/or separation, wherein the at least one support comprises at least one polymethacrylate comprising a polymer of one or more methacrylate monomer types, functionalised with one or more functional groups, and wherein said at least one support is provided with pores having a mean diameter of between about 150 nm and 1850 nm, and which is further characterised in that any pores present in the support having a diameter outside of this range represent less than 5% of the differential pore volume (mL/g) of said support. Certain embodiments provide a chromatographic column comprising a substantially porous a porous monolithic support for use in chromatography, wherein said support comprises at least one polymethacrylate comprising a polymer of one or more methacrylate monomer types, functionalised with at least one functional groups, and wherein said support is provided with pores having a first mean diameter range and a second mean diameter range wherein the second diameter range represents less than 5% of the differential pore volume (mL/g) of said support.

Certain embodiments provide a chromatographic column comprising a support with pores, wherein the pores of the support have a mean pore diameter of between about 180 nm and 850 nm, 320 nm and 1150 nm, 330 nm and 1420 nm, 430 nm and 1740 nm, or 430 nm and 1820 nm. Also, any pores present in the support having a diameter outside of these respective ranges represent less than 5%, more preferably less than 2% and most preferably less than 1%, of the differential pore volume (mL/g). Certain embodiments provide a chromatographic column comprising a polymethacrylate monolithic support according certain aspects disclosed herein.

The embodiments disclosed herein may be used in other conformations. For example, but not limited to, other conformations may include discs for gravity flow filtration and/or plugs for uses such as pressurised flow. Further, a series of supports may be stacked (where, for example, one or more of the supports in the stack differ in mean pore diameter and/or chromatographically functional group, such that a target molecule may be isolated or purified on the basis of multiple characteristics).

The embodiments disclosed herein may be used in a large variety of methods to isolate, purify, filter and/or separate certain target entities. Certain embodiments may be used as methods for isolating or purifying a target molecule (e.g. a biomolecule). For example, such a method may comprise: contacting a sample containing, or suspected of containing, said biomolecule with a polymethacrylate monolithic support under conditions suitable for the molecule to bind (e.g. adsorb and/or absorb) to said support, and thereafter removing the bound molecule from said support.

In certain preferred aspects, the sample comprises a lysed and neutralised cell suspension comprising a desired plasmid DNA (pDNA), the support is a buffer-equilibrated DEAE-Cl functionalised monolithic support, and the step of contacting the sample with the support is achieved by applying the sample to the support at 1 mL/min.

For certain aspects, the isolation or purification of pDNA, the method is preferably operated in accordance with a high performance liquid chromatography method.

Certain methods will typically utilise well known running buffers such as Tris-HCL/EDTA buffer. It is envisaged that some standard “trial and error” experimentation may be undertaken to optimise the pH of the buffers used in the methods disclosed, particularly with respect to an alteration in chromatographically functional group of the support. In certain aspects, the preferred buffers used in the methods disclosed will have a pH of less than 11, and more preferably, will be in the range of about 7.5 to 9 (e.g. about 8.1).

It is also envisaged that certain disclosed methods may comprise one or more washing steps with wash buffers of similar composition to the abovementioned running buffer. The one or more washing steps may be preformed subsequent to binding of the target molecule to remove any residual contaminating material.

In certain disclosed methods, typically, the step of removing the adsorbed and/or absorbed target molecule from the polymethacrylate monolithic support will comprise eluting the molecule with a suitable elution buffer. Elution is preferably achieved by a change in ionic concentration. This may be graduated such that “fractions” may be collected from the support. It is envisaged that some standard “trial and error” experimentation may be undertaken to optimise the concentration of the elution buffer used in certain disclosed methods, particularly with respect to an alteration in chromatographically functional group(s). Preferably, in some aspects the elution buffer will have an ionic concentration weaker than that of the running buffer, and more preferably, will have a NaCl concentration of less than about 0.5 M.

Certain embodiments provide a kit comprising at least one support as disclosed herein together with one or more suitable elution buffers. Certain embodiments provide a kit comprising at least one support as disclosed herein together with one or more suitable elution buffers, wherein the support is a substantially porous support comprises at least one polymethacrylate comprising a polymer of one or more methacrylate monomer types, functionalised with at least one functional group, and wherein said support is provided with pores having a mean diameter of between about 150 nm and 1850 nm and which is further characterised in that any pores present in the support having a diameter outside of this range represent less than 5% of the differential pore volume (mL/g) of said support. Certain embodiments provide a kit comprising at least one support as disclosed herein together with one or more suitable elution buffers, wherein the support comprises at least one polymethacrylate comprising at least one porous, or substantially porous, support for use in purification and/or separation, wherein the at least one support comprises at least one polymethacrylate comprising a polymer of one or more methacrylate monomer types, functionalised with one or more functional groups, and wherein said at least one support is provided with pores having a mean diameter of between about 150 nm and 1850 nm, and which is further characterised in that any pores present in the support having a diameter outside of this range represent less than 5% of the differential pore volume (mL/g) of said support.

Certain embodiments provide a kit comprising at least one support as disclosed herein together with one or more suitable elution buffers, wherein the support is a substantially is a substantially porous a porous monolithic support for use in chromatography and said support comprises at least one polymethacrylate comprising a polymer of one or more methacrylate monomer types, functionalised with at least one functional groups, and wherein said support is provided with pores having a first mean diameter range and a second mean diameter range wherein the second diameter range represents less than 5% of the differential pore volume (mL/g) of said support.

The kits disclosed herein may also comprise one or more running, washing and elution buffers.

In certain embodiments, to achieve a polymethacrylate monolithic support with the required mean pore diameter size of between about 150 nm and 1850 nm, the synthesis of the polymethacrylate involves the use of a porogen. Suitable examples of porogens include, but are not limited to: aliphatic hydrocarbons, aromatic hydrocarbons, alcohols, cyclohexanol, 1-dodecanol, and/or mixtures thereof. Preferably, in certain aspects, the porogen comprises a mixture of cyclohexanol and 1-dodecanol.

As disclosed herein in certain embodiments, the kinetics of pore structure formation and orientation of polymethacrylate monoliths may depend on several factors including, but not limited to, the concentration of cross-linking agent. This may allow the tailoring of the pore characteristics of the monolith to the target molecule. A wide range of average pore diameters may be obtained for polymethacrylate monolith depending on the choice of synthesis conditions and parameters. The average pore diameter range obtained for the embodiments disclosed herein may be due to the variation in synthesis conditions and parameters. As disclosed herein, the effects of these parameters can lead to the trading of the effect of one parameter with the other to achieve the same pore characteristics. In certain embodiments, by preheating and mixing the monomer feed to just below the synthesis temperature before adding to the synthesis chamber, a monolith with a tightly controlled monodispersed pore diameter may be obtained. Additionally, modifications to the synthesis chamber ensure a homogenous and better controlled temperature.

One-step polymerisation reaction in an unstirred mould may be employed for the preparation of certain support embodiments disclosed. In these embodiments, all, or substantially all, of the components of the polymerisation feedstock are in the organic phase. Control of the kinetics of the overall process through changes in reaction time, temperature and overall composition such as cross-linker and initiator contents allow fine tuning of the pore and surface structure thereby yielding varying pore diameters. The all, or substantially all, organic phase nature of the support embodiments disclosed herein as well as the resulting pore structural dynamics proves. In certain embodiments, pore structure dynamics may be important for stationary phase for biomolecule purification. Certain disclosed embodiments may have pore structures that have a monodispersed, or substantially monodispersed pore distribution. In some aspects, these may consist of interconnected globules that are partly aggregated. In some aspects, these pores in the polymer may consist of the irregular voids existing between clusters of the globules or between the globules of a given cluster or even within the globules themselves. These pore size distributions reflect the internal organisation of both the globules and their clusters within the polymer and may depend on the composition of the polymerisation mixture and the reaction conditions.

In certain aspects, the supports used herein may be made using a one-step polymerisation reaction in an unstirred mould. This presents an advantage over other methods because of reduced synthesis times, reduced capital equipment to perform the synthesis, and reduced synthesis complexity leading to reduced opportunity for operator or other error. In addition, the methodologies disclosed herein may create average pore diameter below 500 nm, below 1000 nm, below 2000 nm, above 500 nm, above 1000 nm, above 2000 nm, between 500 and 1000 nm, between 100 and 500 nm, between 200 nm and 800 nm, between 400 nm and 1200 nm, between 600 and 1500 nm, or between 800 nm and 2200 nm which results in a greater level of flexibility in terms of median pores size, pore distribution, voidage space and binding capacity for target biomolecule.

The strategy employed using certain support embodiments disclosed do not camouflage the nature of the target molecule (for example, DNA), that is use chemical, physical, biological or other such means to prevent interactions with the adsorbent but rather these embodiment utilizes the natural and physical properties of the target molecule to enhance the strength of binding and binding capacity of the target for the adsorbent.

As desired in the embodiments disclosed, the pore diameter of the support can be readily varied (e.g. to tailor the support for the target molecule) by using different monomer types, porogen(s) and concentrations and/or different polymerisation temperatures.

Typically, in certain aspects, the amount of the monomer(s) and porogen(s) will be in a monomer(s): porogen ratio ranging from about 20%:80% (v/v) to about 60%:40% (v/v), depending upon the median pore size, pore size distribution, voidage % and other such characteristics desired for the adsorbent to target particular biomolecules of different hydrodynamic diameters and chemical, physical and biological characteristics.

In one preferred embodiment, wherein the polymethacrylate is GMA-co-EDMA, the ratio of GMA:EDMA:porogen is 20:20:60.

In another preferred embodiment, wherein the polymethacrylate is GMA-co-EDMA and the porogen comprises a mixture of cyclohexanol and 1-dodecanol, the ratio of GMA:EDMA:cyclohexanol:1-dodecanol is 20:20:50:10. With this preferred embodiment, alteration of the polymerisation temperatures between about 50° C. to 70° C., allows tailoring of the mean pore diameter to provide, for example, a support with a mean pore diameter between about 180 nm and 850 nm, 320 nm and 1150 nm, 330 nm and 1420 nm, 430 nm and 1740 nm, or 430 nm and 1820 nm.

Certain embodiments, provide a method of producing a polymethacrylate monolithic support comprising the steps of reacting one or more methacrylate monomer types, functionalised with one or more chromatographic functional groups, with a crosslinking agent, wherein said support is provided with pores having a mean diameter of between about 100 nm and 2200 nm and which is further characterised in that any pores present in the support having a diameter <50 nm represent less than 6% of the differential pore volume (mL/g) of said support.

In a still further aspect, the invention provides a method of viral filtration, comprising the steps of providing a polymethacylate monolithic support according to the first aspect of the invention, applying a viral suspension to the monolithic support and eluting viral particles from the monolithic support.

In order that the nature of the present disclosure may be more clearly understood, preferred forms thereof will now be described with reference to the following non-limiting examples.

### EXAMPLES

### Example 1

### Isolation of pDNA with Monolithic Poly(GMA-co-EDMA) Column Functionalised with DEAE-Cl Chromatographically Functional Group Groups

### Materials and Methods

EDMA (M_{w} 198.22, 98%), GMA (M_{w} 142.15, 97%), cyclohexanol (M_{w} 100.16, 99%), 1-dodecanol (M_{w} 186.33, 98%), AIBN (M_{w} 164.21, 98%), MeOH(HPLC grade, M_{w} 32.04, 99.93%), DEAE-Cl (M_{w} 172.10, 97%) were purchased from Sigma-Aldrich. E. coli DH5α cells and pUC19 (0.01 μg/L) were purchased from Invitrogen, tryptone (DIFCO), yeast extract (DIFCO), NH₄Cl (Sigma-Aldrich, M_{w} 53.49, 99.99%), KH₂PO₄ (Merck, 136.09, 99.5%), NaCl (Amresco, MW 58.44, 99.5%), MgSO₄ (Scharlau, M_{w} 120.37, 99.5%), glucose (Merck, M_{w} 180.16, 99.5%), propylene glycol (Fluka, P400), agarose (Promega), SDS (Amresco, M_{w} 288.38, 99.0%), Na₂CO₃ (SPECTRUM, M_{w} 105.99, 99.5%), Tris (Amresco, M_{w} 121.14, 99.8%), EDTA (SERVA, M_{w} 292.3, AG), EtBr (Sigma, M_{w} 394.31, 10 mg/mL), 1 kbp DNA marker (BioLabs, New England), and Wizard plus SV Maxipreps (Promega).

### Synthesis of Methacrylate Monolith and DEAE-Cl Functionalisation of the Epoxy Groups

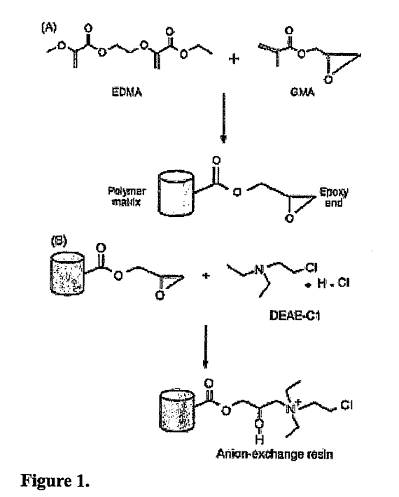

The methacrylate monolith was prepared via free radical liquid porogenic co-polymerisation of EDMA as the crosslinker and GMA as the functional monomer. The EDMA/GMA mixture was combined with cyclohexanol/1-dodecanol as porogen in the proportion 20/20/50/10 (GMA/EDMA/cyclohexanol/1-dodecanol) making a solution with total volume 10 mL. AIBN (1% weight with respect to monomer) was used to initiate the polymerisation process. The polymer mixture was sonicated for 10 min and sparged with N₂ gas to expel dissolved O₂. 5 mL of the mixture was then gently transferred into a 12 cm×1.5 cm polypropylene column (BIORAD) sealed at the bottom end. The top end was sealed with a rubber bung and placed in a water bath for 18 hrs at 50° C. The remaining mixture was polymerised under similar condition in a similar column for characterisation. The polymer resin was then washed to remove all porogens and other soluble matters with methanol in a soxhlet extractor for 20 hrs and dried at 70° C. The polymer was washed with 0.5M Na₂CO₃, 1.0 M NaCl, pH=11.5 followed by the 50 g/L solution of DEAE-Cl and the reaction was allowed to proceed for 15 hrs at 60° C. The resulting resin was washed with DI water for 30 mins and dried at 70° C. The ligand density was found to be 1.85 mmol DEAE-Cl/g resin according to the procedure outlined by Lendero, N. et al., 2005. Reaction schemes for the synthesis and DEAE-Cl functionalisation of poly (GMA-co-EDMA) monolith are shown in FIG. 1.

### Bacterial Batch Fermentation

The plasmid (pUC19 carrying the gene for the α-peptide of lac Z: β-galactosidase and size ˜2.7 kbp) was transformed into E. coli DH5α and propagated in LB plate. A single bacterial colony carrying the plasmid was picked and subcultured with 1 L of LB culture containing 100 mg/L of ampicillin at 37° C. overnight and 200 rpm shaking.

Subsequently, 500 mL of the culture was inoculated into a 20 L fermentor (New Brunswick Scientific, BioFlo 410, USA) vessel containing 15 L of semi-synthesised medium (7.9 g/L of tryptone, 4.4 g/L of yeast extract, 10.0 g/L glucose, 0.24 g/L MgSO₄, 3.0 g/L of KH₂PO₄, 12.8 g/L of Na₂HPO₄ 7H₂O, 0.5 g/L of NH₄Cl) and 100 μg/mL of ampicillin. The temperature was set at 37° C. and the DO maintained at 30% by PID controller, which changed the speed of agitation to maintain the set DO value. The pH was maintained at 7.0 by the addition of 4 M NaOH and 1M HCl. The inflow sparge air was set at 20 psia and foaming was checked by using polypropylene glycol as antifoam. Culture aseptic sampling was performed after every 30 mins to monitor biomass growth. The cultivation was terminated 15 hrs after inoculation, after which the culture broth was harvested, concentrated by ultrafiltration (Millipore, DUOBLOC™, USA), packaged and stored at −75° C. prior to lysis.

### Preparation of Cleared Lysate from Concentrated Cell Paste

The concentrated frozen cells were thawed and resuspended by adding 50 mL of 0.05 M Tris-HCl, 0.01 M EDTA, pH 8 buffer to 5 g of bacterial cell paste and votexing till a uniform suspension was obtained. The resuspended cells were then contacted and homogenously mixed with the same volume of lysis solution (0.2 M NaOH, 1% SDS) for 3 mins. Neutralisation was performed by the addition of an equal volume of 3 M CH₃COOK at pH=5.5 to the lysed cell suspension. This neutralisation step causes renaturation of pDNA through its persistent anchor base pairs under the set pH conditions. After gently mixing for 2 mins, the mixture of pDNA containing lysate and the precipitated impurities, mainly gDNA was separated to obtain a cleared lysate. This clarification step was conducted by centrifugation at 4600×g for 20 mins. The resulting clarified alkaline lysate typically contains pDNA, proteins, RNA, trace fragments of gDNA and lipopolysaccharides.

### Standard Plasmid Preparation: Maxiprep

Standard pDNA purification from the bacterial cell was performed with Wizard plus SV Maxipreps according to the manufacturer's instructions (Promega).

### Characterisation of Polymer Resin

The monolith inside the column was pushed out carefully and dried at 70° C. for 15 hrs and cut into disc-size pieces with a blade. The porous properties in the dry state were studied by Hg intrusion porosimetry, using a micrometrics Hg porosimeter (Autopore III, USA). The specific surface area of the resin was determined using Micromeritics ASAP 2020 instrument, USA via nitrogen adsorption/desorption isotherm. A piece of the monolith was placed on a sticky carbon foil that was attached to a standard aluminium specimen stub. The sample was vapour deposited with gold using a sputter coater (Dynavac, model SC 150, Australia). Microscopic analysis of the sample was carried out using a high resolution field emission scanning electron microscope (JEOL JSM-6300F, Japan) at a voltage of 15 kV.

Anion-Exchange Purification of pDNA

A BIORAD polypropylene column 12 cm×1.5 cm containing 5 mL of DEAE-Cl functionalised monolithic resin was connected with a movable adaptor and configured to BIORAD HPLC system. Chromatographic purification of pDNA was performed using 25 mM Tris-HCl, 2 mM EDTA, 0.2 M NaCl, pH=8.1 as buffer A and 25 mM Tris-HCl, 2 mM EDTA, 1.0 M NaCl, pH=8.1 as buffer B. Prior to purification experiment, the column was column was equilibrated with 3 CV of buffer A. To reconnoitre a proper chromatographic condition, 20 μL of sample of cleared lysate was diluted (×0.5) with buffer A and applied at 1 mL/min. After washing the unbound and weakly retained molecules with buffer A, the ionic strength of buffer A was linearly and stepwisely increased by mixing, proportionally, buffer A with buffer B and bound species eluted.

Quality and Purity of pDNA Samples

The purity and concentration of pDNA samples were determined spectrophometrically at 260 nm and 280 nm. Optical density of 1.0 measured at 260 nm with light path of 1 cm represent 50 mg of dsDNA/L. Absorption measurements taken at wavelengths of 260 nm and 280 nm were used to determine the purity of pDNA based on the ratio OD260/OD280 which is expected to be within 1.7-1.9 to indicate that the sample is free of protein contamination. The nature and size of pDNA were determined by EtBr agarose gel electrophoresis using a 1 kbp DNA ladder. Gel was made up in ×50 dilution of TAE buffer (242 g of Tris base, 57.1 mL CH₃COOH, 9.305 g of EDTA), stained with 3 μg/mL EtBr and run at 66 V for 2 hrs. The resulting fractionated nucleic acid gel was visualised and photographed (BIORAD, Universal Hood II, Italy).

### Results:

### Biomass Growth Kinetics of Batch Fermentation

After an initial lag of 3 hrs, the biomass yield increased to 0.26 g/L and to 4.55 g/L after the next 12 hrs of cultivation. Biomass yield increased continuously throughout the entire cultivation period with the expectation of further increment. This continuous increase in biomass is obviously because of the available amount of carbon source present in the medium for cell growth. Glucose uptake rate and metabolism by cell were enhanced due to O₂ availability resulting from sparged air forced into the system. The maximum growth rate attained during cultivation was 0.45 hr⁻¹.

Dependency of pDNA Size on Ionic Strength of Binding Buffer

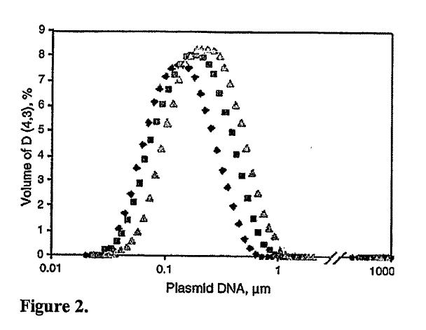

The sizes of standard pDNA samples under different conditions of ionic strength of binding buffer were determined using a mastersizer (Malvern 2000, Australia). The ionic strength of the binding buffer was increased by increasing sodium chloride concentration thus increasing [Na⁺] in solution. Plasmid DNA stock solution in TE buffer (25 mM Tris-HCl, 2 mM EDTA, pH=8.1) was analysed for conformational changes under different ionic strength of the binding buffer. The average D[4,3] readings for 5 runs of pDNA samples are 126 nm, 190 nm and 207 nm in the buffer with NaCl concentrations of 1.0 M, 0.5 M and 0 M respectively (data in Table 1 and sample of data in FIG. 2). The data obtained revealed that at low ionic strength, pDNA molecules are loosely interwound supercoils, while plectonemic superhelices are formed in higher ionic concentration. Plasmid DNA is a highly charged polymer, so the electrostatic repulsion of negatively charged pDNA helices opposes folding and formation of close contacts between charged regions. However, counterions shield the negative charge of pDNA and hence decrease the repulsion between charged segments. Consequently, the geometry of supercoiled pDNA changed at different ionic conditions. Also, a high concentration of metal ions in the pDNA solution resulted in the shrinking of the pDNA molecules; thus reducing plasmid size.

TABLE 1
Plasmid DNA size analysis in different ionic strength of binding buffer TE
(25 mM Tris-HCl, 2 mM EDTA, pH = 8.1) using poly (GMA-co-EDMA) +
DEAE-Cl resin with pore size 300 nm and ligand density 1.85 mmol/g.

| | | Resin | | | |
|---|---|---|---|---|---|
| | | Pore size, nm, | | Binding | |
| pDNA | pDNA size | ligand density, | | capacity, mg/ml | |
| sample | D_{[4,3]}, nm | mmol/g | ΔPavg, MPa | 1 mL/min | 3 mL/min |
| pUC19 + TE + | 207 | poly (GMA-co- | 1.31 | 12.10 | 11.12 |
| 0 M NaCl | | EDMA) + DEAE- | | | |
| | | Cl, 300 nm, 1.85 mmol/g | | | |
| pUC19 + TE + | 190 | poly (GMA-co- | 1.24 | 15.20 | 13.81 |
| 0.5 M | | EDMA) + DEAE- | | | |
| NaCl | | Cl, 300 nm, 1.85 mmol/g | | | |
| pUC19 + TE + | 126 | poly (GMA-co- | 0.95 | 10.32 | 8.94 |
| 1.0 M | | EDMA) + DEAE- | | | |
| NaCl | | Cl, 300 nm, 1.85 mmol/g | | | |

### Characterisation and Performance of Methacrylate Monolithic Resin

### (i) Porosimetry and Surface Characterisation

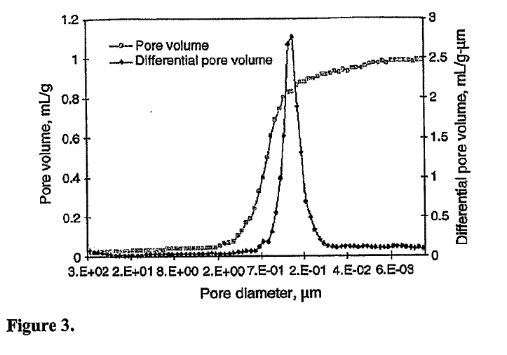

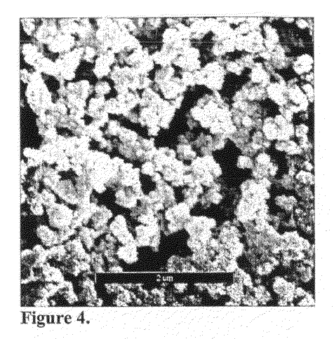

Pores analysis of the resin showed a unimodal pore size distribution with a maximum occurring pore diameter of 300 nm. This value shows a suitable pore diameter for use as a stationary phase for pDNA binding and retention considering the plasmid size under the binding buffer conditions. The total pore volume obtained is 0.95 mL/g and this value represents a good holding and retention capacity of the monolith (FIG. 3). About 70% of the pores within the matrix have diameters greater than 300 nm. The BET surface area of 15.7 m²/g obtained from nitrogen adsorption-desorption isotherm at 77 K shows the existence of relatively few mesopores within the matrix in comparison with macropores. SEM reveals porous network structure of the polymer matrix. FIG. 4 provides an SEM picture showing large pores within the matrix, thereby giving a pictorial confirmation of the pore behaviour obtained.

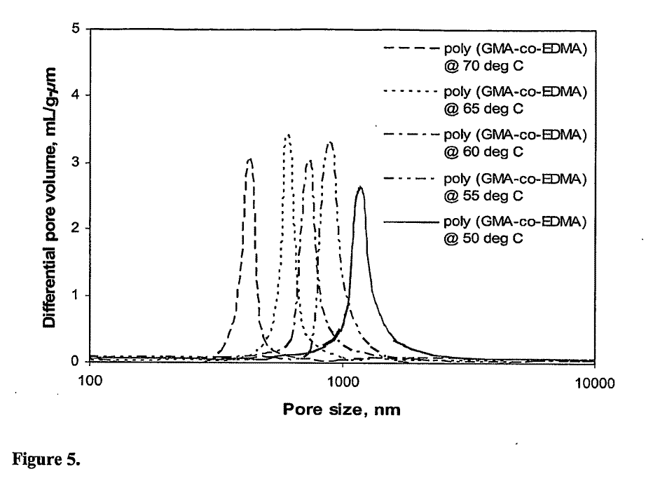

Further, monodispersed monoliths with different pore diameter ranges can be produced by using different monomer and porogen feed stocks and concentrations and/or different polymerisation temperatures in order for the pore size distribution to be tailored for the target molecule. FIG. 5 shows monoliths with pore diameters of between about 180 nm and 850 nm, 320 nm and 1150 nm, 330 nm and 1420 nm, 430 nm and 1740 nm, and 430 nm and 1820 nm for polymerisation temperatures from 50-70° C. where the pore diameter size in a size increment outside of this range represents less than 1% of the differential pore volume (mL/g).

### (ii) Analytical Chromatography

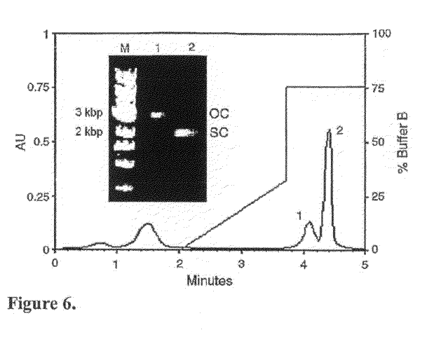

Different concentrations of the plasmid standards were prepared using Wizard Plus SV Minipreps according to the manufacturer's instructions and 5 μL of each injected in the DEAE-Cl functionalised resin to create a calibration curve. Similar chromatographic features were obtained for the different plasmid concentrations. A representative chromatogram for the plasmid samples is shown in FIG. 6. FIG. 6 shows the results of an anion-exchange chromatography purification run of pUC19 pDNA. Stationary adsorbent support phase: DEAE-Cl functionalised methacrylate monolith with active group density 1.85 mmol DEAE-Cl/g resin and modal pore size 300 nm. Chromatographic conditions—Buffer A: 25 mM Tris-HCl, 2 mM EDTA, 0.2M NaCl pH 8.1; Buffer B: 25 mM Tris-HCl, 2 mM EDTA, 1.0M NaCl, pH 8.1; Sample: 5_L of cleared cell lysate. Flow rate, 1 mL/min. Gradient elution, 0-0.325M for 102 s and step elution, 0.325-0.75M for 78 s. Peaks 1 and 2 represent open circular and supercoiled pDNA, respectively. Inset shows EtBr agarose gel electrophoresis of the pDNAfractions. Analysis was performed using 1% agarose in TAE×1 buffer, 3_g/ml EtBr at 66V for 2 h. Lane M is 1 kbp DNA ladder; lanes 1 and 2 represent open circular and supercoiled pDNA, respectively.

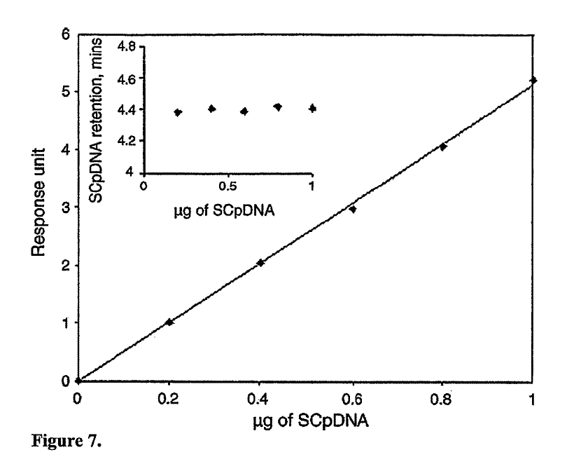

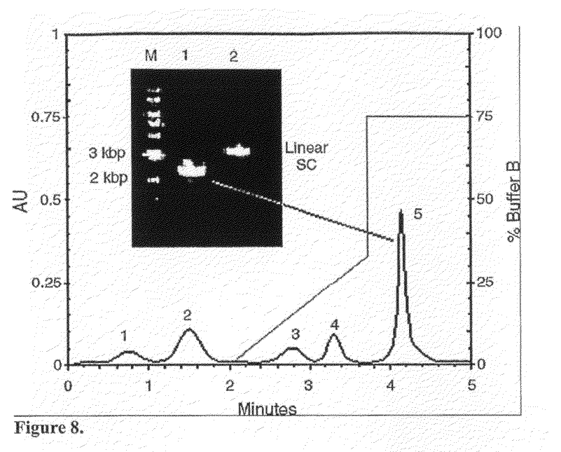

The similar characteristic features of the chromatograms are: a peak at 1.50 mins which corresponds to 25 mM Tris-HCl, 2 mM EDTA, pH=8.1 buffer washing and peaks 1 and 2 showing the presence of open circular and supercoiled plasmid forms at 4.09 mins and 4.40 mins average retention time respectively. The retention time of the supercoiled plasmid was usually in the range 4.38-4.42 mins. The DEAE-Cl functionalised resin was found to be very suitable in the quantification of total supercoiled pDNA. A five point calibration curve was generated for supercoiled plasmid quantity and 260 nm UV absorbance response units (FIG. 7).

(iii) Dynamic Binding Capacity Analysis

The influence of different [Na⁺] on dynamic binding capacity of standard pDNA obtained from Wizard plus SV Maxipreps was studied using the DEAE-Cl functionalised methacrylate resin. As shown in Table 1, the dynamic binding capacity increased (from 12.10 mg/ml to 15.20 mg/mL at 1 mL/min and 11.12 mg/mL to 13.81 mg/mL at 3 mL/min) with increasing [Na⁺] (from 0 M to 0.5 M); representing decreasing pDNA size (from 207 nm to 190 nm). This observation can be explained by the increasing accessibility of the pDNA molecules by the inner functional surfaces of the resin thereby increasing interaction and retention. The results are commensurate with a decreasing pressure drop as pDNA molecules decrease in size and are therefore, unable to block pores existing in the resin matrix. The observation of a pDNA capacity increase was recently reported on the use of compacting agents (Murphy, J. C. et al., 2003). A further increase in [Na⁺] to 1.0 M, decreased pDNA size to 126 nm as expected, but gave a lower dynamic binding capacity of 10.32 mg/ml and 8.94 mg/ml at 1 mL/min and 3 mL/min respectively. This conflicting result is ascribed to the low binding performance associated with high resin pores size to pDNA size ratio; most plasmid molecules pass through the resin unbounded, thus resulting in reduced contact time and binding capacity at a very low pressure drop.

(iv) Single-Stage Purification of pDNA from Cleared Lysate: Preparative Chromatography

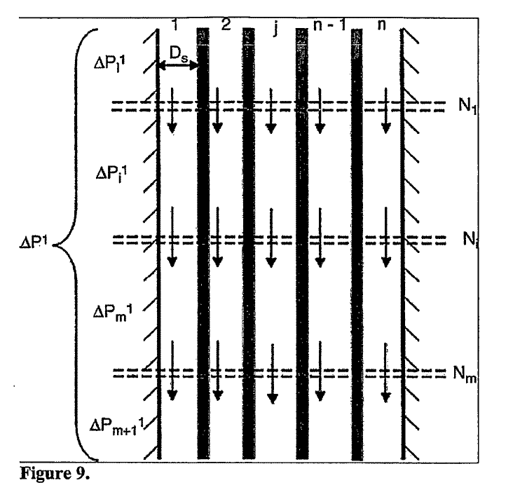

Plasmid DNA, a polymer of deoxyribonucleotides is anionic (two negatively charged phosphate groups per one base pair) over a wide range of pH and can therefore be isolated using DEAE-Cl functionalised resin which is a positively charged matrix. FIG. 8 shows the resulting chromatogram for the direct capturing of pDNA from the cleared lysate. FIG. 8 shows the anion-exchange chromatographic purification of pUC19 pDNA produced in E. coli DH5. A clarified cell lysate was loaded onto a 5.0 mL DEAE-Cl functionalised methacrylate adsorbent support with active group density 1.85 mmol DEAE-Cl/g resin and modal pore size 300 nm. Chromatographic conditions—Buffer A: 25 mM Tris-HCl, 2 mM EDTA, 0.2M NaCl, pH 8.1; Buffer B: 25 mM Tris-HCl, 2 mM EDTA, 11.0M NaCl, pH 8.1, flow rate; 1 mL/min. Peaks 1, 2, 3, 4 and 5 represent loading, washing, RNA, protein and pDNA, respectively. Inset shows results from EtBr agarose gel electrophoresis of pDNA fractions. Analysis was performed using 1% agarose in TAE×1 buffer, 3_/mL EtBr at 66V for 2 h. Lane M is 1 kbp DNA ladder; lanes 1 and 2 represent supercoiled pDNA and linear pDNA obtained from EcoRI cleavage at the sequence GAATTC of the supercoiled pDNA. Gel picture reveals undetectable levels of genomic DNA and RNA contamination. The chromatogram shows co-purification of protein and RNA contaminants resulting from the electrostatic binding between the positively charged matrix and negatively charged RNA and protein molecules existing with the target pDNA molecules in the cleared lysate. Bound RNA, proteins and pDNA molecules were eluted respectively as peaks 3, 4 and 5. Peak elution of the molecules is in order of increasing anionic charge density, a property which is in turn a function of size and conformation for a specific molecule. A pure, supercoiled pDNA fraction was collected from peak 5 as revealed by the inserted EtBr agarose gel electrophoresis. Endotoxins, mainly lipopolysaccharides, contain exposed hydrophobic groups and are therefore unable to interact with the anion-exchange resin; and hence form part of the flow-through. The extent of co-purification of contaminants can be reduced by increasing the ionic strength of the binding buffer (see Discussion below).

### (v) Evaluation of Pressure Drop Across the Monolithic Bed Employing Multi-Nodal Analysis

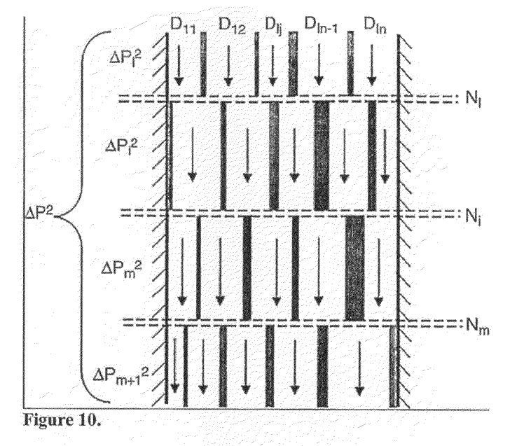

Comparative pressure drop estimation was carried out for different porous monolithic media. The pressure drop across a monolithic bed is dependent on the type of porous media, channel size and network structure. Two types of porous media are considered; the first (FIG. 9) is a monolithic structure made of homogeneous pores having equal diameters with channels not interconnected, and the second (FIG. 10) is a monolithic structure with non-uniformity in pore structure with channels interconnected. Methacrylate monolithic resins synthesised via thermal free radical liquid porogenic copolymerisation of EDMA and GMA show a pore structure similar to the latter. They have a combination of both identical and non-identical structure between nodes with pore interconnectivities. Hence, the entire porous structure is heterogeneous.

Therefore, assuming the same flow rate is applied to both structures, both structures have similar voidage with equal pore volume and that the pore volume existing in a nodal plane Nᵢ is negligible. Dₛ is the pore diameter of the first porous media, Dⱼ is a pore diameter existing in the second porous media and ΔPᵢ^{k} (k=1, 2) is the pressure drop across Nᵢ₋₁ and Nᵢ nodal planes for porous media 1 and 2. Considering the first structure, pores of the same length have the same pore volume and since nodal planes are considered at the same intervals the pressure drop between successive nodal planes is the same. For m number of nodal planes,

ΔP₁¹=ΔP₂¹= . . . =ΔPᵢ¹=ΔPᵢ₊₁¹= . . . =ΔPₘ¹=ΔPₘ₊₁¹ [1]

Consequently, the total pressure drop ΔP¹ over the bed is given by;

$$\begin{matrix}Δ {P}^{1} = Δ {P}_{1}^{1} + Δ {P}_{2}^{1} + … + Δ {P}_{i}^{1} + Δ {P}_{i + 1}^{1} + … + Δ {P}_{m}^{1} + Δ {P}_{m + 1}^{1} \\ = {\sum }_{i = 1}^{i = m + 1} Δ {P}_{i}^{1} \\ = ( m + 1 ) Δ {P}_{i}^{1}\end{matrix} \qquad [ 2 ]$$

Total pore volume, Vₚ₁ existing in pore media 1;

$${V}_{p 1} = n ( m + 1 ) \frac{π {D}_{s}^{2}}{4} \qquad [ 3 ]$$

For the second structure, pore diameters between nodes are different so the pressure drops are different for any two consecutive nodal planes. Liquid flowing through this structure can randomly switch through the nodal planes from one pore to the other.

ΔP₁²≠ΔP₂²≠ . . . ≠ΔPᵢ²≠ΔPᵢ₊₁²≠ . . . ≠ΔPₘ²≠ΔPₘ₊₁² [4]

Consequently, the total pressure drop ΔP² over the bed is given by;

$$\begin{matrix}Δ {P}^{2} = Δ {P}_{1}^{2} + Δ {P}_{2}^{2} + … + Δ {P}_{i}^{2} + Δ {P}_{i + 1}^{2} + … + Δ {P}_{m}^{2} + Δ {P}_{m + 1}^{2} \\ = {\sum }_{i = 1}^{i = m + 1} Δ {P}_{i}^{2}\end{matrix} \qquad [ 5 ]$$

Total flow-through in media 2 is equal to the sum of the individual flows in all the pores. Dᵢⱼ represents the diameter of the j^{th} pore entering the i^{th} nodal plane. Total pore volume, Vₚ₂ existing in pore media 2;

$$\begin{matrix}{V}_{p 2} = \frac{π}{4} ( {\sum }_{j = 1}^{j = n} {D}_{1 j}^{2} + {D}_{2 j}^{2} + … + {D}_{ij}^{2} + … + {D}_{mj}^{2} + {D}_{( m + 1 ) j}^{2} ) \\ = \frac{π}{4} {\sum }_{j = 1}^{j = n} {\sum }_{i = 1}^{i = m + 1} {D}_{ij}^{2}\end{matrix} \qquad [ 6 ]$$

Since the total pore volume for structures 1 and 2 are the same,

$$\begin{matrix}{V}_{p 1} = {V}_{p 2} n ( m + 1 ) \frac{π {D}_{s}^{2}}{4} \\ = \frac{π}{4} {\sum }_{j = 1}^{j = n} {\sum }_{i = 1}^{i = m + 1} {D}_{ij}^{2} ⇒ n ( m + 1 ) {D}_{s}^{2} \\ = {\sum }_{j = 1}^{j = n} {\sum }_{i = 1}^{i = m + 1} {D}_{ij}^{2}\end{matrix} \qquad [ 7 ]$$

Pressure drop of a laminar flow through a cylindrical pore can be computed using the Hagen-Poiseuille equation. Application of Hagen-Poiseuille equation on structure 1 gives;

$${ϕ}_{v}^{1} = n ( m + 1 ) π \frac{Δ {P}^{1} {D}_{s}^{4}}{128 η L} \qquad [ 8 ]$$

Application of Hagen-Poiseuille equation on structure 2 gives;

$$\begin{matrix}{ϕ}_{v}^{2} = \frac{π}{128 η L} {\sum }_{j = 1}^{j = n} Δ {P}_{1 j} {D}_{1 j}^{4} + Δ {P}_{2 j} {D}_{2 j}^{4} + … + Δ {P}_{ij} {D}_{ij}^{4} + … + \\ Δ {P}_{mj} {D}_{mj}^{4} + Δ {P}_{( m + 1 ) j} {D}_{( m + 1 ) j}^{4} \\ = \frac{π}{128 η L} {\sum }_{j = 1}^{j = n} {\sum }_{i = 1}^{i = m + 1} Δ {P}_{ij} {D}_{ij}^{4}\end{matrix}$$

Since the total pore volume existing in structures 1 and 2 are considered the same,

$$\begin{matrix}n ( m + 1 ) π \frac{Δ {P}^{1} {D}_{s}^{4}}{128 η L} = \frac{π}{128 η L} {\sum }_{j = 1}^{j = n} {\sum }_{i = 1}^{i = m + 1} Δ {P}_{ij} {D}_{ij}^{4} ⇒ n ( m + 1 ) {D}_{s}^{4} Δ {P}^{1} \\ = {\sum }_{j = 1}^{j = n} {\sum }_{i = 1}^{i = m + 1} Δ {P}_{ij} {D}_{ij}^{4}\end{matrix} \qquad [ 9 ]$$

Combining equations [7] and [9] gives;

$$\frac{{\sum }_{j = 1}^{j = n} {\sum }_{i = 1}^{i = m + 1} \frac{Δ {P}_{ij}}{Δ {P}^{1}} {D}_{ij}^{4}}{{D}_{s}^{2} {\sum }_{j = 1}^{j = n} {\sum }_{i = 1}^{i = m + 1} {D}_{ij}^{2}} = 1 \qquad [ 10 ]$$

Considering a single nodal plane (i=1) of a non-uniform methacrylate monolithic structure which is bimodal (j=2) with modal pore diameters D₁ and D₂ in the ratio

$$\frac{{D}_{1}}{{D}_{2}} = ξ ,$$

and assuming the monolith has a structure of parallel type non-uniformity, the pressure drop analysis for this system is carried out in comparison with a monolith of uniform structure having the same pore volume, single node (i=1) and unimodal pore diameter D₀.

Pore volume equality for the 2 systems can be written as;

$${D}_{0}^{2} = \frac{{D}_{1}^{2}}{2} + \frac{{D}_{2}^{2}}{2} = \frac{{D}_{2}^{2}}{2} ( 1 + \frac{{D}_{2}^{2}}{{D}_{1}^{2}} ) = \frac{{D}_{1}^{2}}{2} ( 1 + \frac{1}{{ξ}^{2} } ) \qquad [ 11 ]$$

Applying Hagen-Poiseuille equation to evaluate pressure drop and equalising results gives;

2ΔP₀D₀⁴=ΔP₁D₁⁴+ΔP₂D₂⁴ [12]

For parallel type non-uniform structure, the total pressure drop above (ΔP₁) and below (ΔP₂) the nodal plane are the same; hence ΔP₁=ΔP₂=ΔP

$$2 Δ {P}_{0} {D}_{0}^{4} = Δ P ( {D}_{1}^{4} + {D}_{2}^{4} ) = Δ P {D}_{1}^{4} ( 1 + \frac{{D}_{2}^{4}}{{D}_{1}^{4}} ) = Δ {PD}_{1}^{4} ( 1 + \frac{1}{{ξ}^{4}} ) \qquad [ 13 ]$$

Combining equations [11] and [13] gives;

$$\frac{Δ {P}_{0}}{Δ P} = 2 ( 1 + \frac{1}{{ξ}^{4}} ) {( 1 + \frac{1}{{ξ}^{2}} )}^{- 2} \qquad [ 14 ]$$

Differentiating equation [14] gives;

$$\frac{d ( Δ {P}_{0} / Δ P )}{d ξ} = \frac{8 ξ}{{( {ξ}^{2} + 1 )}^{2}} ( {ξ}^{2} - \frac{{ξ}^{4} + 1}{{ξ}^{2} + 1 } ) \qquad [ 15 ]$$

The minimum value of (ΔP₀/ΔP) occurs at =1

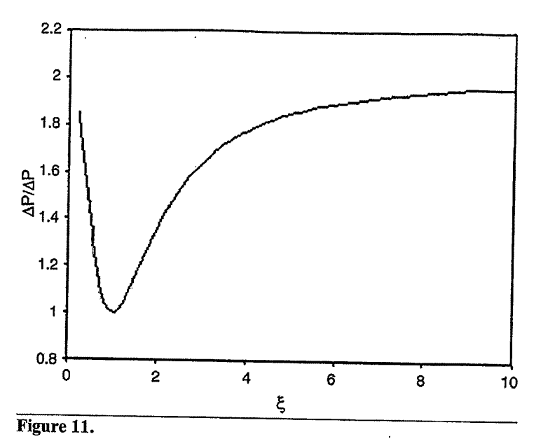

The dependency of pressure drop on media type is shown in FIG. 11 for the single node structure with parallel type non-uniformity. It is clear that for 0<ξ<1, the parallel type non-uniform structure gives a higher pressure drop in comparison to the structure with uniform pore size distribution. For ξ≧1, the parallel type non-uniform structure gives a lower pressure drop in comparison to the structure with uniform pore size distribution. The profile obtained shows that low pressure drop can be obtained simply by modifying the pore size distribution. For a methacrylate monolith, this can be achieved by altering synthesis conditions such as polymerisation temperature, reactant mixture composition and heat transfer coefficients.

### Discussion

### Effect of Ionic Strength on Co-Purification of Contaminants

The effect of increasing ionic strength of binding buffer can sufficiently be exploited as a strategy to avoid unnecessary adsorption of low charge density impurities such as low molecular weight RNA and proteins. Under the condition of high ionic strength of binding buffer, impurities gradually elute in the flow-through and the entire capacity of the resin can be fully utilised for pDNA adsorption. This would result in a decrease in binding of undesired proteins and RNA, hence gradual diminishing of the RNA and protein peaks and increase in the pDNA concentration and purity. Also a decrease in plasmid elution time and increase in plasmid recovery with increasing ionic strength of binding buffer could be realised.

Effect of pH on pDNA Binding and Elution

Plasmid DNA is a large molecule and highly negatively charged. Due to its size and charge, pDNA molecules interact with a positively charged resin through several binding sites; hence the consequent interaction is very strong. The high charge density associated with pDNA molecule enables its stability under variable pH. Therefore, any change in a characteristic parameter indicating chromatographic performance under variable pH system almost certainly results from a change in property of the adsorbent employed. Bencina, M. et al., 2004 observed the results of pH variation employing three types of DNA: pDNA (pDNA size 5 kbp), lDNA (gDNA size 50 kbp), and gDNA with a broad molecular weight distribution up to 200 kbp. They investigated the effect of pH by changing the pH value of the mobile phase between 7 and 12. Retention of pDNA, lDNA and gDNA injected on a DEAHP (weak anion-exchanger) column significantly decreased at higher pH values. This decrease in retention was attributed to DEAHP groups since the pH variation was not expected to significantly influence the charge on the DNA. To confirm this, they conducted a similar experiment using a monolithic column containing QA group, which is a strong anion-exchanger and does not change activity in the tested pH range. A comparison of DNA retention behaviour shows that the displacer concentration required for DNA elution remains similar on QA columns over the entire pH range, while there is a drastic decrease in DEAHP columns for pH values above 8, reaching no retention at pH=11.

### CONCLUSION

The unit operations of fermentation and lysis are vital stages for the production and release of pDNA from a bacterial system. However, the incorporation of monolith affects the process from the filtration stage onwards by offering fast separation at high flow rate and through-put under a reduced number of unit operations. The work described herein utilised a methacrylate monolithic sorbent specifically tailored for direct capturing of the target pDNA molecule. Characterisation of the resin showed pore and surface properties for optimum binding and retention of the pDNA molecule considering its dimension. The final product obtained after 5 minutes purification employing the resin, was a supercoiled pDNA with no RNA or protein contamination and was found to meet regulatory standards. The sorbent displayed the potential to reduce the number of unit operations required to capture pharmaceutical grade pDNA from greater than three to one-stage purification. Scale-up and economic consideration show that this cost effective and a cGMP compatible procedure can be advanced to a commercial level.

### Example 2

The pore structure of the methacrylate monoliths may depend on temperature shifts due to exotherms involved in the synthesis of large-volume methacrylate monoliths. Heat build-up due to the heat associated with initiator decomposition and the heat released from free radical-monomer and monomer-monomer interactions may cause problems. Expulsion of a portion of the heat of decomposition of the initiator as well its accompanying fumes prior to polymerisation will help to minimize the amount heat build-up during the polymerisation. By using this technique, the polymerisation will commence with the free radical (resulting from the initiator decomposition) with minimal heat build up. This approach is supported by review of the mathematics on heat balances to predict the effect of the heat expulsion step on the temperature profile within the mould for a cylindrical monolith since monoliths with cylindrical geometry relatively exhibits a lower pressure drops. The mathematical modelling of the temperature profile during polymerisation in a closed mould is quite complex. The main problem is the flow by convection inside the mould caused by radial temperature gradients during the polymerisation. The convective flow enhances heat transfer that influences the radial temperature profile and the polymerisation rate.

### Example 3

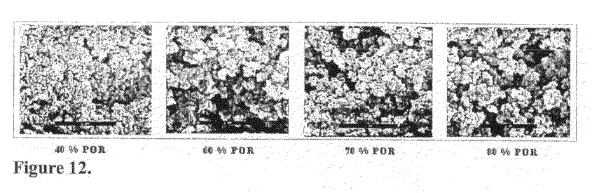

This example shows the effect porogen content may have on certain polymer characteristics in certain disclosed embodiments. In this example, it is shown how the composition and concentration of the porogen, for example cyclohexanol, may have an effect on the properties of the polymer, including, but not limited to, the pore size distribution and median pore size within the polymer matrix. The existence of the porogen in the polymerisation mixture may impact the permeability and homogeneity of the pore structure. This is believed to be due to the physicochemical characteristics of the porogen that lead to phase separation of cross-linked nuclei. Phase separation of cross-linked nuclei is often a prerequisite for the formation of the polymer morphology. The polymer phase is believed to separate from the solution during polymerisation because of its sparingly solubility in the polymerisation mixture that results from a molecular weight that exceeds the solubility limit of the polymer in the given solvent system or from insolubility associated with cross-linking. According to Table 2, increasing the amount (% v/v) of porogen from 40-80% resulted in an increase in pore size from 116-876 nm with a final porosity of 87%. SEM pictures of the monoliths are shown in FIG. 12. As expected, the total surface area of the polymer decreased with increasing porogen content to a minimum of 2.3 m²/g. In general, the more the cyclohexanol content in the polymerisation mixture, the higher the permeability and the lower the total surface area of poly(EDMA-co-GMA) monolithic polymers. The mechanical strength of the polymer was also found to decrease with increasing porogen quantity. Table 2 shows the effect of cyclohexanol (porogen) concentration in the polymerisation mixture on the pore and surface characteristics of methacrylate monolith. Polymerizations were carried out with a constant monomer ratio (EDMA/GMA) of 40/60 (% v/v); polymerisation temperature of 60° C.; A1BN concentration of 1% w/w of monomers (n=3).

TABLE 2

| Porogen | Total intrusion | Modal pore | | BET surface |
|---|---|---|---|---|
| conc., % v/v | volume, ml/g | diameter, nm | Porosity, % | area, m²/g |
| 40 | 0.62 0.09 | 115.75.9 | 35.5 ± 1.5 | 26.20.6 |
| 50 | 0.79 ± 0.07 | 235.64.5 | 46.9 ± 1.3 | 22.40.5 |
| 60 | 0.93 ± 0.06 | 346.57.2 | 65.2 ± 0.9 | 11.80.7 |
| 70 | 1.33 ± 0.08 | 532.66.1 | 79.3 ± 1.4 | 7.1 ± 0.8 |
| 80 | 1.43 ± 0.05 | 875.63.4 | 87.4 ± 1.2 | 2.3 ± 0.6 |

FIG. 12 shows the effect of cyclohexanol (porogen) concentration in the polymerisation mixture on the surface morphology of methacrylate monolith. Polymerizations were carried out with a constant monomer ratio (EDMA/GMA) of 40/60; polymerisation temperature of 60° C.; AIBN concentration of 1% w/w of monomers. The SEM pictures show increasing pores size with increasing concentration of porogen in the polymerized feedstock. Microscopic analysis was performed at 15 kV.

### Example 4

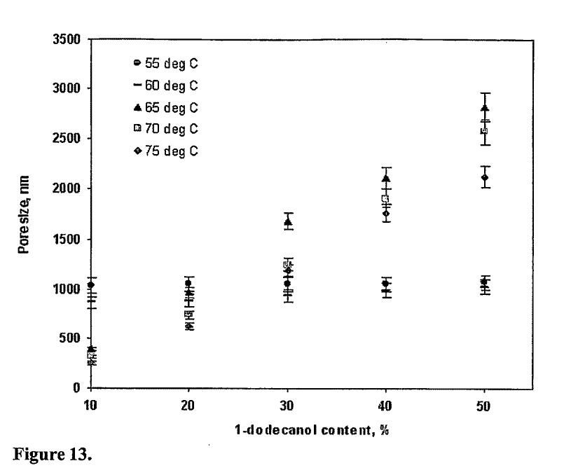

In this example, the effect that binary porogen systems may have on polymer characteristics of certain embodiments. More specifically, how the addition of a co-porogen to the polymerisation mixture may influence the pore size distribution of the polymer matrix. Results shown in FIG. 13 show that, the effect of altering 1-dodecnol concentration was found to be significant especially within the polymerisation temperature range of 65-75° C. However, the effect of 1-dodecanol is insignificant for polymerisation performed at 55° C. since the polymerisation or nucleation rate at this temperature is so slow that the pore size is always large. A gradual removal of 1-dodecanol from 50% to 10% of the total porogen content results in the decrease of pore size from 2824 nm to 395 nm at 65° C. 1-dodoecanol is a poor solvent and as such is believed to present no competition towards nucleation and precipitation in the polymerisation mixture. The addition of a poor solvent results in an earlier phase separation of the polymer. The resulting new phase swells with the monomers because it is thermodynamically much better solvent for the polymer than the porogenic solvent. As a result of this preferential swelling, the concentration of monomers in the swollen gel nuclei is higher than that in the solution; hence the polymerisation reaction proceeds it is believed mainly in these swollen nuclei. Newly formed nuclei are adsorbed by the large preglobules formed earlier by coalescence of many nuclei and further increase their size. Overall, the globules that are formed in such a system are larger and consequently the voids between them are larger as well. The effect of adding a good solvent to move the distribution toward smaller pore sizes can be readily explained by considering that phase separation occurs in the later stages of polymerisation. In this case the cross-linking agent dominates the phase-separation process. As the pore-forming solvent quality improves, it competes with the monomers in the formation of nuclei; thereby reducing the local monomer concentration and this decreases the size of the globules. FIG. 13 displays the dependency of average pore size on the presence of 1-dodecanol as a co-porogen for polymers synthesized at different temperatures. Polymerizations were carried out with a constant monomer ratio (EDMA/GMA) of 40/60; polymerisation temperatures of 55° C., 60° C., 65° C., 70° C., 75° C. AIBN concentration of 1% w/w of monomers.

### Example 5

This example shows the effect of solid porogen on the pore characteristics of a polymer according to certain embodiments. In this example, the reaction of a carbonate and a dilute acid which results in the formation of carbon dioxide was used as a technique to increase the pore size of poly(GMA-co-EDMA) resin. The effect of the solid porogen, in this case a carbonate (used as a porosigen) was found to affect the pore properties of the polymer matrix.

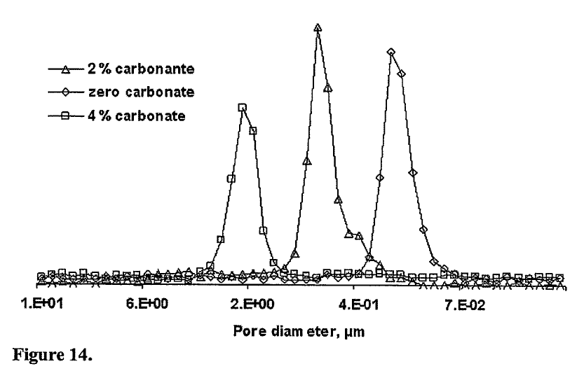

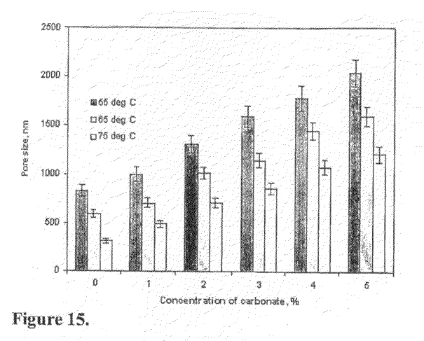

As shown in FIG. 14, the average pore size of different methacrylate monolithic resins was increased after the addition of a carbonate as a solid porogen. Gradual increase in the concentration of carbonate in the polymerisation mixture corresponded with increasing pore size at different temperature (FIG. 15). The removal of the added carbonate after the polymerisation was achieved by pumping and washing the resin severally with dilute hydrochloric acid which resulted in the occurrence of effervescence leading to the evolution of carbon dioxide gas. This washing step is halted until effervescence ceases which is an indication of total removal carbonate. The escape of embedded carbonate as carbon dioxide from the polymer matrix results in the creation of extra pores or pore enlargement right from inter-globule to inter-cluster level. Incorporation of large quantities of the carbonate results in large pore sizes but puts extra stress on the polymer washing step. FIGS. 14 and 15 illustrate the dependency of pore size distribution on the presence of a carbonate as a solid porogen. Polymerizations were carried out with a constant monomer ratio (EDMA/GMA) of 40/60; polymerisation temperature of 60° C.; AIBN concentration of 1% w/w of monomers. FIG. 15 shows the effect of the presence of a carbonate as solid porogen on the average pore size of poly(GMA-co-EDMA) adsorbent support for different polymerisation temperatures. Polymerizations were carried out with a constant monomer ratio (EDMA/GMA) of 40/60; polymerisation temperatures of 55° C., 65° C., 75° C.; AIBN concentration of 1% w/w of monomers.

### Example 6

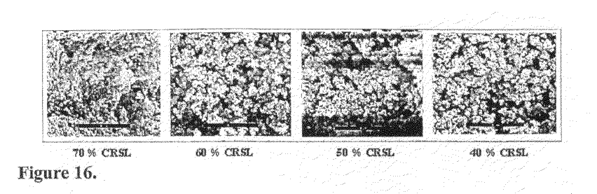

This example shows the dependency of pore and surface properties of the monolith on EDMA/GMA ratio in accordance with certain embodiments. In this example, the monomer ratio is shown to affect the permeability, surface area and mechanical strength of poly(GMA-co-EDMA) monolith as well its composition. Changes in EDMA/GMA ratio were achieved by varying proportionally the amount of EDMA in the polymerisation mixture. As obtained according to Table 3, the presence of more EDMA in the polymerisation mixture decreases the pore size of the resulting polymer, hence decreasing permeability and pore volume. EDMA is the cross-linking monomer and as a result it is believed to propagate and form extensive polymer networks via the formation of covalent bonds linking the different polymer chains to achieve properties, such as, but not limited to, higher tensile strength, impact modification and large surface area. Although variables such as temperature and porogenic system affect the polymer porosity without changes in composition, the concentration of the cross-linking agent affects the porous properties and composition of polymer network. This behavior is believed to be due to the fact that an increase in the EDMA concentration leads to the formation of more cross-linked nuclei. The higher cross-linking density of the nuclei limits their swelling so it is believed monomer diffusion into the nuclei and the real coalescence of formed nuclei in the later stage of the reaction do not occur. Therefore the micro-globule formed is small and consequently the voids between them are smaller as shown in FIG. 16.

Table 3 shows the effect of the ratio of monomers (EDMA/GMA) in the polymerisation mixture on the pore and surface characteristics of methacrylate monolith. Polymerizations were carried out with monomer ratios of 30/70, 40/60, 50/50, 60/40 and 70/30 (% v/v); polymerisation temperature of 55° C.; AIBN concentration of 1% w/w of monomers; porogen concentration of 70% v/v feedstock (n=3).

TABLE 3

| EDMA/GMA, | Total intrusion | Modal pore | Porosity, | BET surface |
|---|---|---|---|---|
| % v/v | volume, ml/g | diameter, nm | % | area, m²/g |
| 30/70 | 1.410.08 | 1072.78.2 | 93.41.3 | 1.20.8 |
| 40/60 | 1.050.06 | 825.55.6 | 85.11.5 | 5.30.6 |
| 50/50 | 0.860.05 | 652.17.5 | 66.31.2 | 10.40.8 |
| 60/40 | 0.690.04 | 426.84.8 | 59.21.6 | 16.30.5 |
| 70/30 | 0.420.07 | 312.76.4 | 41.21.7 | 21.60.7 |

FIG. 16 shows the effect of the ratio of monomers (EDMA/GMA) in the polymerisation mixture on the pore and surface morphology of methacrylate monolith. Polymerizations were carried out with monomer ratios of 70/30, 60/40, 50/50 and 40/60; polymerisation temperature of 55° C.; AIBN concentration of 1% w/w of monomers; porogen concentration of 70% v/v feedstock. The SEM pictures show increasing pores size with decreasing monomer ratio in the polymerized feedstock. Microscopic analysis was performed at 15 kV.

### Example 7

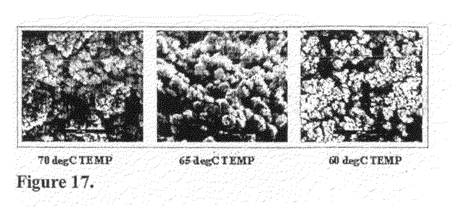

This example shows the effect of polymerisation temperature on the pore characteristics of the polymer, according to certain embodiments. In this example, polymerization temperatures of 55, 60, 65, and 70 were used to show the effect of polymerization temperature on intrusion volume, modal pore diameter, porosity, and BET surface area. Table 4 and FIG. 17 illustrate the effect of temperature on the pore size of poly(GMA-co-EDMA) monolith. The higher the polymerisation temperature, the smaller the pore size. This is believed to be explained by the initiator decomposition rate because at a higher reaction temperature, more free radicals are generated per unit time and these overwhelm the remaining monomers in the polymerisation feedstock so more nuclei and micro-globules are formed. Because the monomer concentration is the same for each polymerisation reaction, the formation of a larger number of nuclei and micro-globules at high temperatures is balanced by a decrease in their size. As a result, smaller pore sizes exist between them. It is believed that the shift in pore size distribution induced by changes in the polymerisation temperature can be accounted for by the difference in the number of nuclei that result from such changes. Therefore, temperature may constitute a tool for obtaining poly(EDMA-co-GMA) monoliths with different pore sizes from the same composition of feedstock.

Table 4 below shows the effect of polymerisation temperature on the pore and surface characteristics of methacrylate monolith. Polymerizations were carried out with monomer ratio of 40/60 (% v/v); polymerisation temperatures of 55° C., 60° C., 65° C., 70° C.; AIBN concentration of 1% w/w of monomers; porogen concentration of 75% v/v feedstock (n=3).

TABLE 4

| Temperature, | Total intrusion | Modal pore | | BET surface |
|---|---|---|---|---|
| deg C. | volume, ml/g | diameter, nm | Porosity, % | area, m²/g |
| 55 | 0.980.05 | 828.76.3 | 75.31.8 | 7.30.8 |
| 60 | 0.720.07 | 702.34.5 | 66.41.4 | 13.40.6 |
| 65 | 0.640.06 | 593.17.7 | 52.31.6 | 18.20.7 |
| 70 | 0.560.04 | 416.23.2 | 45.61.2 | 23.90.5 |

FIG. 17 shows the effect of polymerisation temperature on the pore and surface morphology of methacrylate monolith. Polymerizations were carried out with monomer ratio of 40/60; polymerisation temperatures of 60° C., 65° C., 70° C.; AIBN concentration of 1% w/w of monomers; porogen concentration of 75% v/v feedstock. The SEM pictures show increasing pores size with decreasing polymerisation temperature. Microscopic analysis was performed at 15 kV.

### Example 8

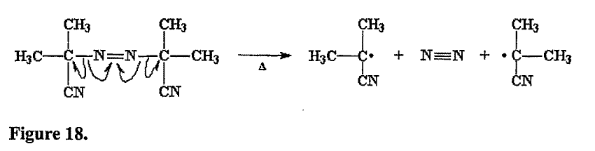

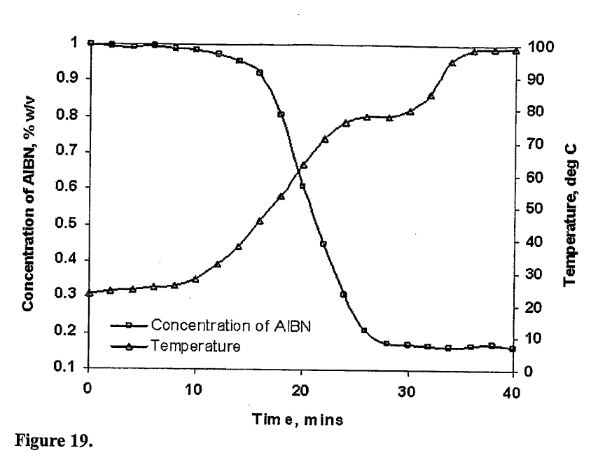

This example shows the dependency of the pore structure of the polymer on initiator concentration according to certain embodiments. In this example, it is shown that a thermal free radical initiator that may be moderately stable at room temperature decomposes with sufficient rapidity at the polymerisation temperature to ensure an appreciable reaction rate. Apart from temperature, the decomposition rate of a free radical initiator depends on the porogen solvent and/or monomers used. The confining effect of the porogen molecules causes unwanted reactions including recombination of radicals to regenerate the initiator. The confining effect becomes more significant as viscosity increases. The decomposition of 1% w/v AIBN (FIG. 18) in 5 mL cyclohexanol at a maximum set temperature of 100° C. was studied. Mass loss due to AIBN decomposition was determined as the difference between the mass of AIBN/cyclohexanol mixture and only cyclohexanol at different time intervals. The results show that the decomposition of AIBN in the cyclohexanol commenced at a temperature of 40-50° C. due to the sharp decrease in the concentration of AIBN resulting from mass loss by the evolution of N₂ gas according to FIG. 18. The corresponding sharp increase in temperature confirms this observation as the decomposition of AIBN is an exothermic reaction thereby increasing the overall system temperature. Increasing the concentration was AIBN in the polymerisation mixture was also studied according to FIG. 19. It was observed that increasing initiator concentration increases the rate of polymerisation which results in late phase separation; a phenomenon which it is believed leads to small-size nuclei and hence globules formation resulting in decrease in pore size. Increasing initiator content from 0.5% (w/w of monomers) to 1.5% (w/w of monomers) results in the decrease in pore size from 980 nm to 410 nm.

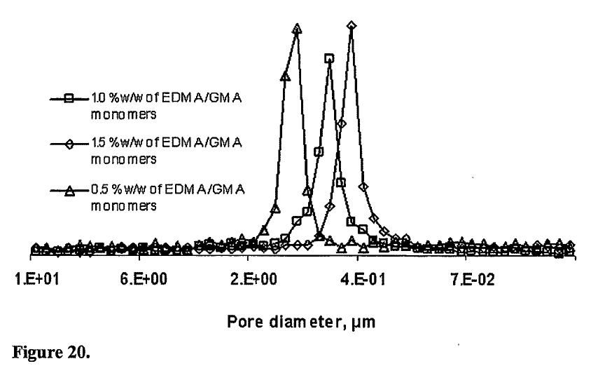

FIG. 18 shows the reaction scheme for the decomposition of azobisisobutyronitrile (AIBN). Reaction shows the formations of free radicals with the evolution of N₂ gas. FIG. 19 shows the decomposition of 1% w/v of AIBN in cyclohexanol at a maximum set temperature of 100° C. Data show AIBN decomposition temperature of 40-50° C. with a corresponding decrease in the concentration of AIBN owing to the evolution of N₂ gas. FIG. 20 shows the dependency of pore size distribution on AIBN concentration. Polymerizations were carried out with a monomer ratio of 40/60; polymerisation temperature of 60° C.; AIBN concentration of 0.5% w/w, 1.0% w/w and 1.5% w/w of monomers; porogen concentration of 75% v/v feedstock.

### Example 9

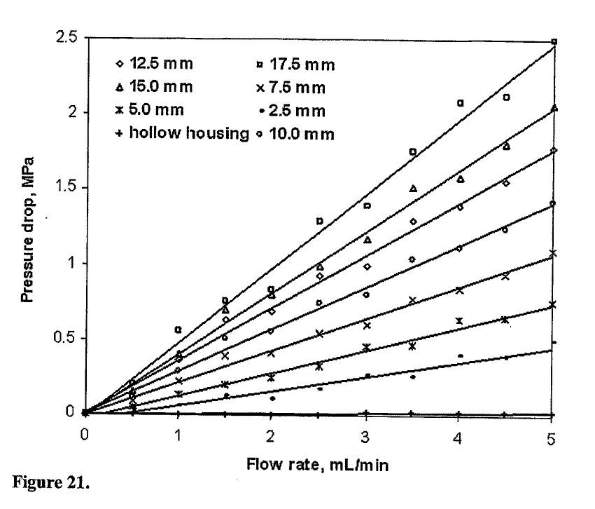

This example shows the effect of flow rate and pressure drop on certain embodiments. In this example, pressure drops at different flow rates were measured with different volumes of the methacrylate resin with average pore sizes of 570 nm in polypropylene columns of 15 mm diameter. It is often desirable for a stationary phase used in the purification of biomolecules either on semi-preparative or preparative scale of separation to allow the use of variable flow rates under tolerable pressure drops. Certain of the embodiments disclosed herein are designed for high flow rates. The volume of the resin in the column was varied simply by adding known volume discs of the methacrylate monolith into the polypropylene housing. Generally, a linear relationship was observed between the pressure drop and the flow rate for the different volumes of methacrylate resin as shown in FIG. 21 and this depicts that the porous structure of the resin is stable and does not contract at higher flow rates. However, the pressure drop was found to increase with increasing volume of the methacrylate resin due to the increase in length of travel and this is in agreement with Hagen-Poisseuille equation under laminar conditions. A maximum pressure of 2.5 MPa was recorded at a flow rate of 5 mL/min for 17 mm length of column which is generally on the low side. The possibility to run the monolithic column at high flow rates, under low pressure drops, shows that separation and purification of biomolecules can be achieved within a very short time. FIG. 21 shows the dependence of the measured pressure drop on flow rate and length (volume at constant diameter) of the monolithic layer having an average pore diameter of 570 nm. Pressure drop increases with increasing flow rate and increasing length of the monolithic layer.

### Example 10

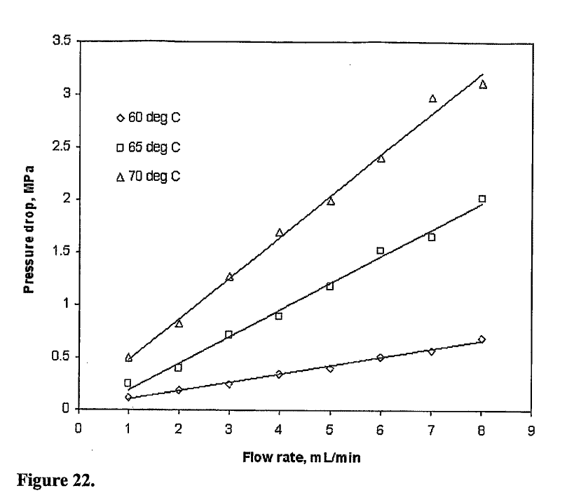

Resistance to flow may be important in certain chromatographic separations. Often it is desirable that the pressure needed to drive the liquid through the monolithic resin should be as low as possible. This can often be achieved in certain circumstances by employing material with a high percentage of large pores. However, binding of biomolecules to the stationary phase also requires a large surface area and therefore a balance has must be set between the requirements of low flow resistance and high surface area. This compromise can easily be drawn by knowing the hydrodynamic dimension and the nature of the target molecule and tailoring the structural characteristics of the methacrylate monolithic resin using the parameters outlined earlier to suit its binding, retention, elution and general flow dynamics. FIG. 22 demonstrates the effect of flow rate through cylindrical rods of methacrylate monolith synthesized under different temperature conditions. A general trend in pressure drop increase was observed with increasing flow rate and temperature since increasing polymerisation temperature was found to decrease the pore size of the methacrylate resin. FIG. 22 shows the dependency of measured pressure drop on flow rate for different monoliths polymerized at different temperatures 60° C., 65° C. and 70° C. Polymerizations were carried out with monomer ratio of 40/60; AIBN concentration of 1.0% w/w of monomers; porogen concentration of 65% v/v feedstock. Generally, an increase in pressure drop was observed with increasing polymerisation temperature.

### Example 11

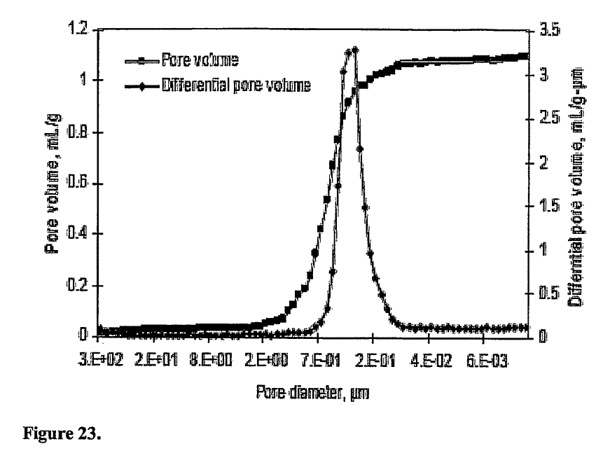

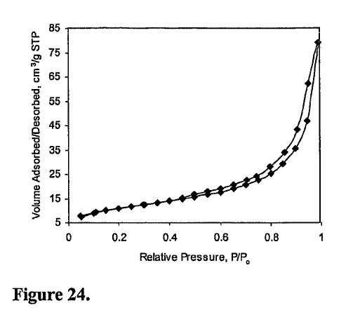

This example characterizes certain monolithic resins, according to certain embodiments. In this example, a pore analysis was performed using mercury intrusion porosimetry which showed that the adsorbent support had a unimodal pore distribution with a maximum pore diameter occurring in the range between 350-375 nm according to FIG. 23. This data showed that the adsorbent support has a pore diameter suitable for pDNA binding and desorption as the hydrodynamic radius of the pDNA used in this example (pUC19) was shown to be ˜200 nm as displayed in Table 1 and FIG. 2. The total pore volume of the resin was 1.1 ml/g, which demonstrates a good retention capacity of the monolith. About 68% of the pores within the matrix have diameters greater than 300 nm. The BET surface area of 12 m²/g obtained from nitrogen adsorption-desorption isotherm at 77 K (FIG. 3) shows the existence of relatively few mesopores within the matrix in comparison to macropores. Scanning electron micrographs, displayed in FIGS. 4, 11 and 12 reveal the porous network structure of the polymer matrix. FIG. 3 shows the cumulative pore volume and differential pore volume against pore diameter of monolith composed of 50%:50% v/v GMA/EDMA using mercury intrusion porosimeter. The plot shows a modal pore diameter of 350-375 nm existing in the matrix as differential pore volume is a measure of the number of representation of each pore diameter as pore volume during the pressurized entry of mercury into matrix. A total pore volume of 1.11 mL/g was obtained. FIG. 2 shows a pUC19 plasmid DNA size analysis Malvern Mastersizer 2000 (UK). Hydrodynamic size of ˜200 nm was obtained. FIG. 24 shows the nitrogen adsorption-desorption isotherm at 77 K for the methacrylate monolithic polymer matrix. BET surface area of 12 m²/g was obtained from this isotherm. FIG. 4 shows SEM picture for monolithic polymer matrix composed of 50%:50% by volume GMA/EDMA. The picture shows large through-pores of the monolith and the cross-linked structure of the polymerized feed stock. Picture of monolith is obtained at ×20000 magnification and 15 kV

### Example 12

This example shows an anion-exchange purification of plasmid DNA from clarified lysate in accordance with certain embodiments. FIG. 8 shows the resulting chromatogram for the purification of pDNA from clarified lysate. As it can be seen from the chromatogram there was a co-purification of protein and RNA contaminants resulting from the electrostatic binding between the positively charged matrix and negatively charged RNA and protein molecules existing with pDNA in the clarified lysate. RNA, proteins and pDNA were eluted respectively as peaks 3, 4 and 5 after increasing ionic strength of the buffer. Peak elution of the molecules is in the order of increasing anionic charge density, a property which is in turn a function of size and conformation of the molecule. A certain amount of RNA was found with the pDNA fraction collected from peaks 5 as revealed by the inserted EtBr-AGE picture. FIG. 8 shows an anion-exchange chromatographic purification of pDNA from E. coli DH5α-pUC19 clarified lysate using DEAE-Cl functionalised methacrylate monolith with active group density 2.25 mmol DEAE-Cl/g resin and modal pore size 350-375 nm. Chromatographic conditions—Buffer A: 25 mM Tris-HCl, 2 mM EDTA, pH=8.1, Buffer B: 25 mM Tris-HCl, 2 mM EDTA, 1.0 M NaCl, pH=8.1, Sample: 20 μL of cleared cell lysate. Flow rate; 1 mL/min. Gradient elution, 0-0.325 M for 102 s and Step elution, 0.325-0.75 M for 78 s. Peaks 1, 2, 3, 4 and 5 represent loading, washing, RNA, protein and pDNA respectively. Inset: Results from EtBr-AGE of RNA and pDNA fractions. Analysis was performed using 1% agarose in TAE×1 buffer, 3 μg/ml EtBr at 66 V for 2 hours. Lane M is 1 kbp DNA ladder; lanes 1 and 2 represent RNA and pDNA fractions respectively. Picture reveals RNA traces in the pDNA fraction.

### Example 13

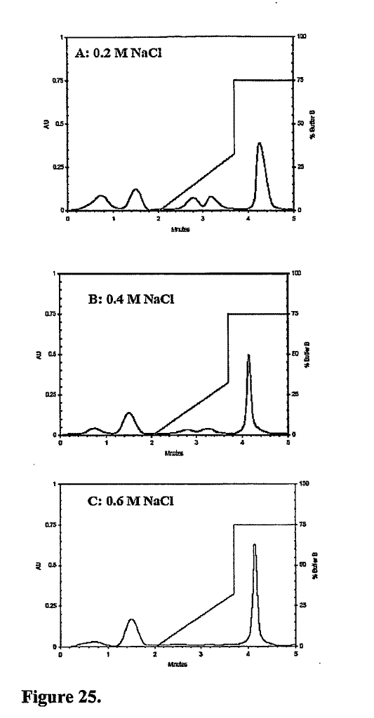

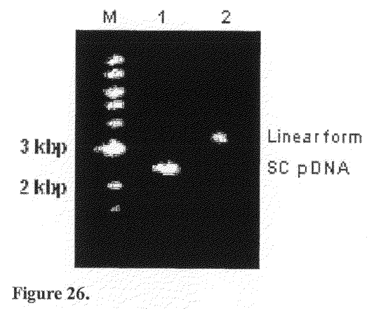

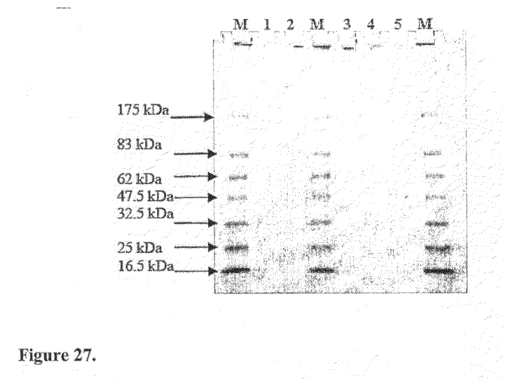

This example shows the effect of ionic strength on co-purification of contaminants in accordance with certain embodiments. In this example, the effect of increasing ionic strength of the binding buffer was used to avoid unnecessary adsorption of low charge density impurities such as low molecular weight RNA and proteins thereby increasing purity of pDNA. Under the condition of high ionic strength of the binding buffer, impurities gradually flow through and the entire capacity of the resin can be fully utilised for pDNA adsorption. Increasing ionic strength by increasing [NaCl] of the binding buffer in the order 0.2 M→0.4 M→0.6 M was investigated in this case (FIG. 25 (A, B, C)). The DEAE-Cl functionalised resin was equilibrated with selected binding buffer before use. This resulted in a decrease in the binding of undesired proteins and RNA, hence gradual diminishing of the RNA and protein peaks and an increase in the pDNA concentration and purity. Also there was a corresponding decrease in plasmid elution time (retention) and increase in plasmid recovery. The final plasmid obtained is a pure SC pDNA free from RNA and protein contamination as shown by the EtBr-AGE (FIG. 26) and SDS-PAGE (FIG. 27) images. FIG. 25 shows the effect of ionic strength of loading buffer on binding, retention and elution of pDNA from clarified lysate as well as reduction of copurification of RNA and protein contaminants. Stationary phase: DEAE-Cl functionalised methacrylate monolith with active group density 2.25 mmol DEAE-Cl/g resin and modal pore size 350-375 nm. Mobile phase: 25 mM Tris-HCl, 2 mM EDTA, pH=8.1 containing 0.2 M, 0.4, 0.6 M NaCl. Sample: 20 μL of cleared cell lysate. Flow rate; 1 mL/min. Final plasmid obtained is a pure SC pDNA. FIG. 26 shows the results from EtBr-AGE of pDNA fraction from final chromatographic purification with mobile phase 25 mM Tris-HCl, 2 mM EDTA, 0.6 M NaCl, pH=8.1. Analysis was performed using 1% agarose in TAE×1 buffer, 3 μg/ml EtBr at 66 V for 2 hours. Lane M is 1 kbp DNA ladder; lane 1 represents supercoiled pDNA fraction and lane 2 shows band for linear form obtained from EcoRI cleavage at the sequence GAATTC of the final plasmid. Gel picture reveals no band for contaminants. FIG. 27 shows an SDS-PAGE picture for the final plasmid sample obtained form DEAE-Cl functionalised monolithic purification.

Analysis was performed using BIORAD pre-cast poly-acrylamide gel in TSG (Tris-SDS-Glycine) buffer at 130 V for 90 mins and stained with a coomassie blue solution. Lane M represents a pre-stained protein marker; lanes 1, 2, 3, 4 and 5 represent wells loaded with different concentrations pDNA (25.8 μg/mL, 20.3 μg/mL, 15.8 μg/mL, 10.2 μg/mL and 5.4 μg/mL respectively). Gel picture reveals no band for protein in the samples.

### Example 14

This example looks at the binding capacity and economic consideration of certain ion-exchange resins, in accordance with certain embodiments.

On the basis of the results obtained in the above examples, the ion-exchange resins disclosed herein may be used for the purification of pDNA. The results obtained were compared with results for anion-exchange beads found in literature. The total capacity of the resin was estimated by dividing the mass of pDNA bound to the support by its volume. Capacity of 12 mg/mL obtained based on 0.5 mL disc of sample of the DEAE-Cl functionalised resin was found to be amongst the best to date in literature. Commercially available anion-exchange resins for pDNA purification have binding capacities in the range of 0.5-8 mg/mL. See Peters, E. C.; Svec, F.; Frechet, J. M. J. Chem Mater 1997, 9, 1898, and Viklund, C.; Svec, F.; Frechet, J. M. J. Chem. Mater 1996, 8, 744. However, it is the economic viability and reusability/regeneration of the resin embodiments disclosed herein that makes them more attractive for biomolecule purification especially on the commercial level. Cost and budget calculations where carried out for the synthesis and fictionalization of certain resin embodiments disclosed herein based on cost of monomers, porogen, initiator, volumetric cost of N for purging, cost quantification of electricity for water bath heating and drying, cost of DEAE ligand and general miscellaneous with regards to monolith washing. The cost of production per liter of the resin was therefore compared to the commercially available ones. The estimated cost of the DEAE-Cl functionalised polymeric resin is $ 92 per litre resin which is less than most commercially-available sorbents for plasmid purification. The cost of fictionalization with DEAE-Cl ligand forms about 10% of the total cost. The energy cost for the fictionalization is taken into account, as this needs a temperature of 60° C. Table 5 shows the binding capacity and cost per liter data obtained for different commercially-available sorbents compared with the DEAE-Cl monolithic resin. Plasmid DNA binding capacities were obtained using the same feedstock and conditions.

TABLE 5

| | Binding capacity, | US $ Cost per |
|---|---|---|
| Stationary phases | mg/mL | Liter |
| DEAE sepahrose FF | 0.263 | 732 |
| Q ceramic HyperD 20 | 6.162 | 1253 |
| Toyopearl DEAE 650 M | 0.390 | 721 |
| Fractogel EMD DEAE (S) | 5.443 | 809 |
| Source 30Q | 0.707 | 1351 |
| BIA-CIM DEAE | 8.856 | 1725 |
| DEAE-CL monolithic | 12.062 | 92 |
| resin** | | |

Table 6 shows the binding capacity of DEAE-Cl functionalised resin with modal pore size in the range 350-375 nm and ligand density 2.25 mmol/g measured at 1 mL/min in repeated loadings with column regeneration. Resin shows re-establishment of binding capacity after several uses and regeneration.

TABLE 6

| Number of loadings | Binding capacity, mg/mL |
|---|---|
| 1 | 12.4 |
| 2 | 12.4 |
| 3 | 12.1 |
| 4 | 11.7 |
| 5 | 11.3 |
| | Resin regeneration |
| 6 | 12.5 |
| 7 | 12.1 |
| 8 | 11.8 |
| 9 | 11.7 |
| 10 | 11.5 |

### Example 15

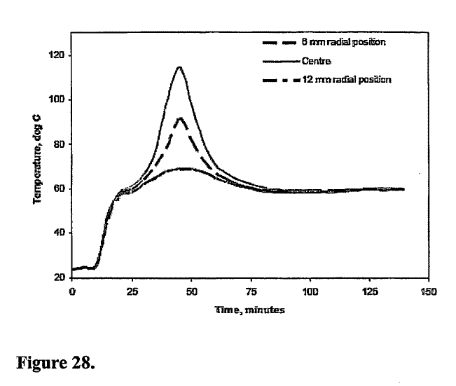

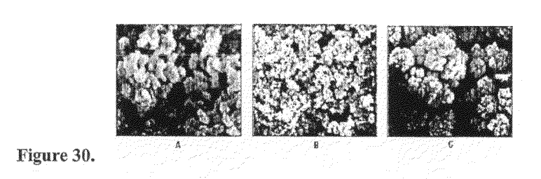

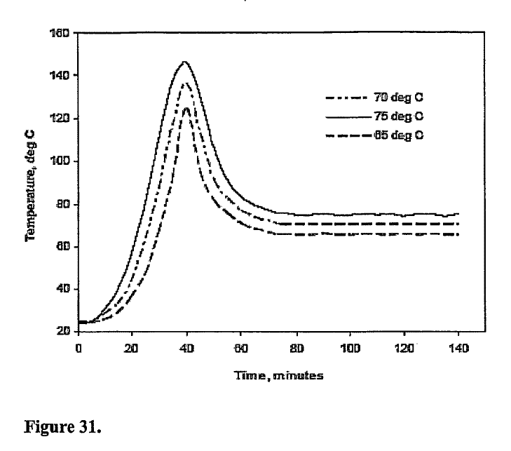

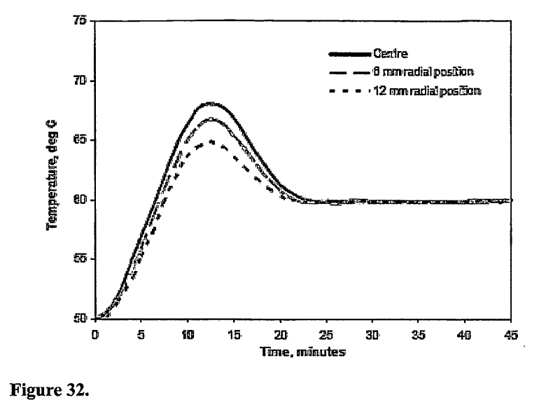

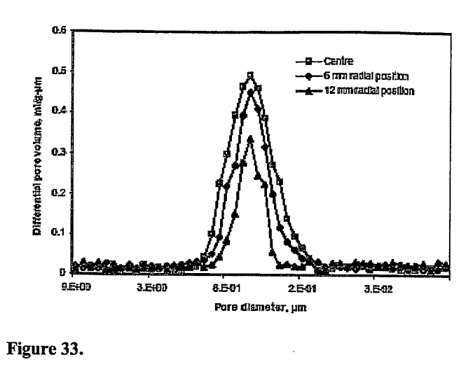

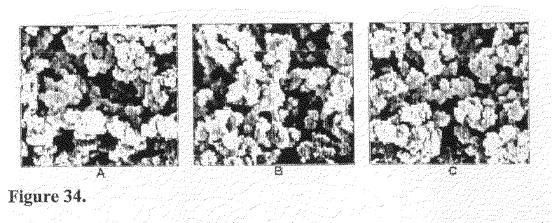

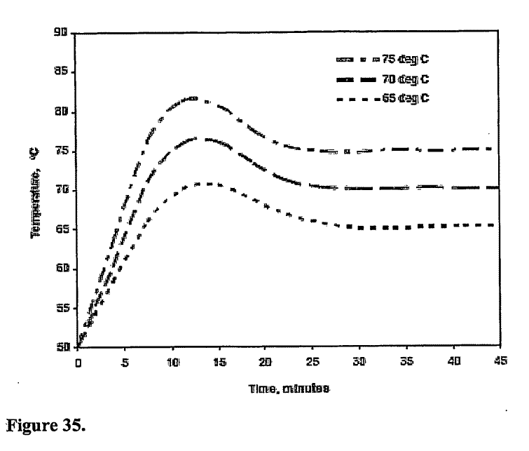

This example discusses the bulk synthesis of methacrylate monoliths in accordance with certain embodiments. In this example, the synthesizing of homogeneous large-volume methacrylate monolith via bulk polymerisation was carried out by preparing 80 mL monolith in the 20 cm×2.5 cm mould using a typical polymerisation feedstock with AIBN initiator at an initial temperature of 60° C. An aggressive evolution of exothermic fumes occurred during the polymerisation, leading to a monolith with a disfigured surface. The exothermicity of the reaction was enough to increase the reaction temperature from its initial level and to accelerate the polymerisation rate owing to the rapid decomposition of the initiator with an accompanying release of nitrogen gas. The characteristic temperature distribution during the polymerisation inside the mould at different radial positions (centre, 6 mm and 12 mm points) is presented in FIG. 28. The reactant mixture is prepared at room temperature and placed into a thermostated water bath at 60° C. During the heating process, the temperature of the reactant mixture steadily approaches the water bath temperature. At this point, the initiator becomes thermally unstable and starts to decompose to free radicals that activate polymerisation. The degree of exothermicity associated with the bulk polymerisation causes an increase in the polymerisation temperature, which accelerates the reaction kinetics and as a result aggravates the evolution of exotherms. This causes a substantial temperature gradient in the radial direction as the polymerisation system is no longer able to effectively distribute the heat of polymerisation. The self-accelerated reaction retards when the system shorts in monomer concentration and finally the polymerisation stops. According to FIG. 28, the maximum temperature established at the centre was ˜115° C.; an increase of 55° C. over the water bath temperature. The deviation from the desired polymerisation temperature is reflected in the radial difference in the pore properties of the monolith. FIG. 33 represents the pore size distributions at the different radial positions of the monolith. There is a high degree of inconsistency in the pore size distribution at the different radial positions, as the pore size profiles present different pore size modalities and arrangements in the matrix. Morphological studies of samples sliced from the different radial positions as in FIG. 30 displays distinct features of pore interconnectivities for the each of the different samples. The monolith thus prepared was practically of no use. The monolith synthesis was carried out at different polymerisation temperatures to study the effect of temperature on the extent of exothermicity at a specific radial position. FIG. 31 represents the comparison between the temperature profiles at the centre position for polymerizations at 65° C., 70° C. and 75° C. An impact of the polymerisation temperature on the reaction rate kinetics and the maximum temperature reached is observed. Higher polymerisation temperature increases the rate of polymerisation and the maximum temperature reached. This results in a non-uniform structure of the monolith. FIG. 32 shows the temperature distribution profiles in the radial direction along the length of the 80 mL monolith for bulk polymerisation. Radial points investigated are the centre, 6 mm and 12 mm positions. FIG. 32 shows the highest temperature gradient of 8.5° C. established at the centre. FIG. 33 shows pore size distribution of samples sliced from the different radial positions (centre, 6 mm and 12 mm) of the 80 mL poly(GMA-co-EDMA) monolith synthesized via bulk polymerisation. The different portions of the monolith display different pore size distributions, thereby rendering the entire pore structure non-uniform. FIG. 34 shows SEM pictures of the 80 mL monolithic polymer synthesized via bulk polymerisation. FIG. 34 pictures A, B and C show the micrographs of samples sliced from the different radial positions; centre, 6 mm and 12 mm respectively. Pictures display the heterogeneous nature of the pore system. FIG. 35 shows a comparison of experimentally measured temperature distributions at the centre of the mould during bulk polymerisation of 80 mL monolith at different water bath temperatures; 65° C., 70° C. and 75° C. Maximum temperature gradient increases with increasing polymerisation temperature.

### Example 16

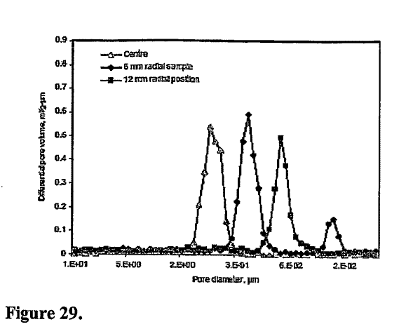

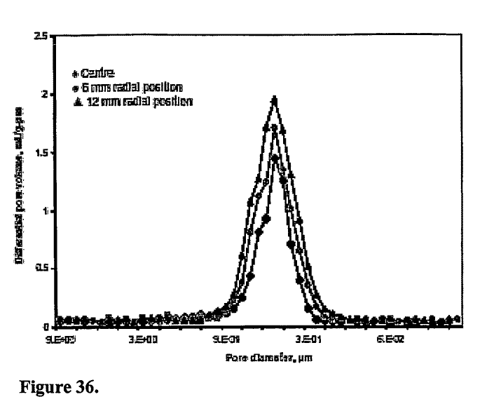

This example shows a large-volume methacrylate monolith synthesis via heat expulsion and bulk polymerisation, in accordance with certain embodiments. In this example, temperature is shown to be a factor in the control of the pore structure of methacrylate monoliths. As shown in Example 15 above, during the bulk synthesis of large-volume methacrylate monolith in accordance with certain embodiments, the occurrence of high radial temperature gradient usually will occur which may result in a non-uniform pore structure in the prepared monolith. The large amount of heat generated during the bulk polymerisation process can be disintegrated into the heat evolutions resulting from initiator decomposition, monomer-monomer and monomer-initiator interactions within the porogen. To obtain a lower heat generation to cause a lower radial temperature gradient, AIBN/cyclohexanol mixture was preheated separately to initiate AIBN decomposition, resulting heat/fume expelled and the free radical-porogen mixture transferred instantly into the polymerisation mould containing preheated monomer mixture at the same temperature as the free radical-porogen mixture. The temperature of the system was increased to the polymerisation temperature as quickly as possible after the bulk addition. In the mould, polymerisation commenced very quickly after the free radicals have contacted the monomers. The heat evolved further increases the temperature of the system beyond the polymerisation temperature to a maximum less than that observed during the bulk polymerisation (FIG. 36). The expulsion of the heat of initiator decomposition reduces the large amount of heat responsible for high temperature gradients during the bulk polymerisation. The monolith embodiments prepared by this approach is relatively free of deformities, with homogeneity in the pore size distributions of the different samples analyzed. The radial temperature profiles measured during the polymerisation confirm that the improvement in pore structure homogeneity indeed results from the decrease in exothermicity. As shown in FIG. 32, the maximum recorded temperature is 68.5° C. at the centre, which is 8.5° C. higher than the actual polymerisation temperature. Comparing this to that of the bulk polymerisation gives a 46.5° C. reduction in temperature gradient. This radial temperature gradient reduction may be attributable to the heat expulsion step included in this methodology. As shown in FIG. 34, the SEM pictures of samples from the different radial positions show that the morphology of the different portions is similar. The pores in the matrix are interconnected, forming a porous network of channels. FIG. 28 shows a temperature distribution profile in the radial direction along the length of the 80 mL monolith synthesized via heat expulsion and bulk polymerisation. Radial points investigated are the centre, 6 mm and 12 mm positions. FIG. 28 shows that the highest temperature gradient of 8.5° C. was established at the centre. FIG. 29 shows the pore size distributions of samples sliced from the different radial positions (centre, 6 mm and 12 mm) of the 80 mL poly(GMA-co-EDMA) monolith. The different portions of the monolith display pore size distributions with improved uniformity. An identical modal pore diameter of ˜400 nm for certain embodiments is shown by the different samples. FIG. 34 shows SEM pictures of the 80 mL monolithic polymer synthesized via heat expulsion and bulk polymerisation. FIG. 34 pictures A, B and C show the micrographs of samples sliced from the different radial positions; centre, 6 mm and 12 mm respectively. FIG. 34 pictures display an improvement in the uniformity of the pore structure.

### Example 17

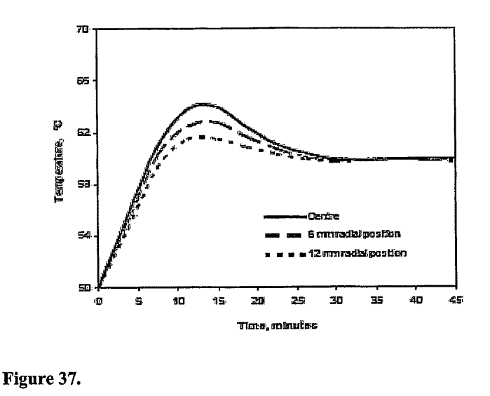

This example shows large-volume methacrylate monolith synthesis via heat expulsion and gradual addition polymerisation, in accordance with certain embodiments. In this example, AIBN/cyclohexanol mixture was preheated separately to initiate AIBN decomposition and the resulting free radical-porogen mixture pumped continuously and isothermally into the polymerisation mould after the heat/fumes from AIBN decomposition has been expelled. The monomer mixture was also pumped simultaneously under substantially identical conditions into the polymerisation mould. In the mould, polymerisation commenced very quickly after the free radicals have contacted the monomers. The heat evolved further increases the temperature of the system beyond the polymerisation temperature to a maximum far less than that observed during the bulk polymerisation (as shown in FIG. 37). The expulsion of the heat of decomposition considerably reduces the large amount of heat responsible for high temperature gradients during the polymerisation. Also the continuous and gradual introduction of monomer and free radical/porogen mixtures into the polymerisation mould minimizes the heat evolved during the polymerisation as the mass of feedstock per unit time is limited. By this technique, the polymer grows slowly upward from the bottom of the mould. The monolith prepared in this manner is substantially free of deformities, with substantial homogeneity in the pore size distributions of different samples from the different radial positions as shown in FIG. 36. The radial temperature profiles measured during the polymerisation confirm that the improvement in pore structure homogeneity indeed results from the decrease in exothermicity. The maximum recorded temperature as shown in FIG. 37 was 64.3° C. at the centre, which is only 4.3° C. higher than the actual polymerisation temperature. The reduction in the radial temperature gradient and hence the resulting pore structure uniformity is as an improvement over that reported in the art, see Peters, E. C.; Svec, F.; Frechet, J. M. J. Preparation of Large-Diameter “Molded” Porous Polymer Monoliths and the Control of Pore Structure Homogeneity. See Chem. Mater. 9 (1997) 1898 for only gradual addition polymerisation. Accordingly, the embodiments disclosed may be used to efficiently produce homogeneity, or substantial homogeneity, in the pore structure of certain large-volume methacrylate monoliths. FIG. 37 shows that with the heat expulsion techniques as disclosed herein, increasing the polymerisation temperature does not significantly affect the radial temperature gradient as the greater portion of the heat causing excessive exothermicity is expelled. Maximum radial temperature gradients of only 5.4° C., 5.9° C. and 6.7° C. were recorded for polymerisation temperatures 65° C., and 75° C. respectively. FIG. 36 shows the temperature distribution profiles in the radial direction along the length of the 80 mL monolith synthesized via heat expulsion and gradual addition polymerisation. Radial points investigated are the centre, 6 mm and 12 mm positions. FIG. 37 shows the highest temperature gradient of only 4.3° C. established at the centre. FIG. 36 shows a pore size distribution of samples sliced from the different radial positions (centre, 6 mm and 12 mm) of the 80 mL poly(GMA-co-EDMA) monolith. The different portions of the monolith display substantially identical pore size distribution with a high degree of homogeneity. A substantially identical modal pore diameter of ˜400 nm is revealed by the different samples. FIG. 34 shows SEM pictures of the 80 mL monolithic polymer synthesized via heat expulsion and gradual addition polymerisation. FIG. 34 pictures A, B and C show the micrographs of samples sliced from the different radial positions; centre, 6 mm and 12 mm respectively. Pictures display identical pore structure. FIG. 35 shows a comparison of experimentally measured temperature distributions at the centre of the mould during the 80 mL methacrylate monolith synthesis via heat expulsion and gradual addition polymerisation at different water bath temperatures; 65° C., 70° C. and 75° C. Increasing the polymerisation temperature does not significantly affect the maximum radial temperature gradient.

### Example 18

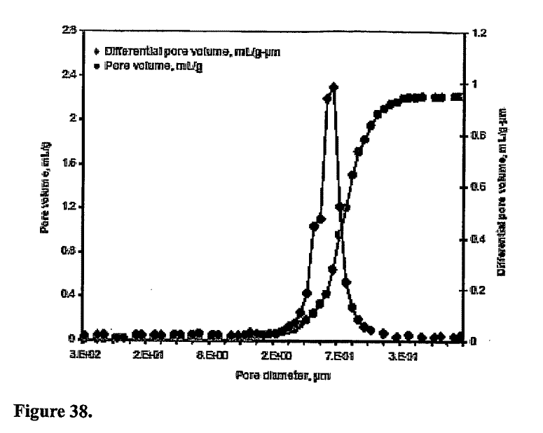

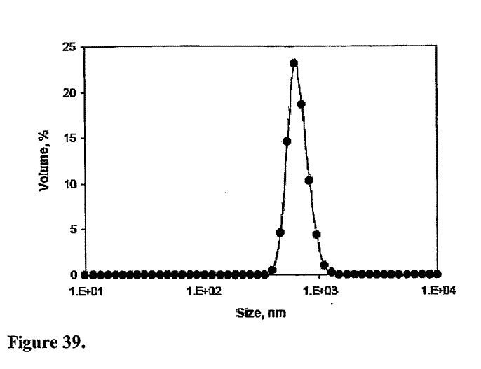

This example discusses the pore characteristics of certain monolithic polymers prepared in accordance with certain disclosed embodiments. In this example, the adsorbent structure was evaluated at different radial positions to determine that variation in intrusion volume, modal pore diameter, porosity, and BET surface area as a function of radial position. The results obtained from the pore analysis show a common, or substantially common, unimodal pore size distribution for different samples sliced from different radial positions (centre, 6 mm and 12 mm), with a substantially identical maximum occurring pore diameter of 750 nm according to FIG. 38. This value shows a suitable pore diameter of the monolith as a stationary phase for the plasmid vaccine molecule penetration and retention considering the plasmid (pVR1020-PyMSP4/5) molecular hydrodynamic size of ˜600 nm (FIG. 39). The total pore volume of the polymer is 2.20 mL/g and the BET surface area obtained from N₂ adsorption/desorption isotherm at 77 K is 7.1 m²/g. About 75% of the pores within the matrix have diameters greater than 650 nm. FIG. 38 shows the average cumulative pore volume and differential pore volume against pore diameter of the methacrylate monolithic polymer using Hg intrusion porosimeter. The plot shows a modal pore diameter of 750 nm existing in the matrix and a total pore volume of 2.20 mL/g. FIG. 39 shows a pVR1020-PyMSP4/5 molecular size analysis in TE buffer (25 mM Tris-HCl, pH=8) using a zetasizer (Malvern zetasizer, ZEN 3600, UK). A hydrodynamic size of approximately ˜600 nm was obtained. Table 7 is a summary of the pore characteristics of the methacrylate polymer. The polymer feedstock compositions: EDMA/GMA mixture (40/60% v/v) combined with cyclohexanol/AIBN mixture in the proportion 25/75% v/v. Polymerisation was performed at 60° C. Data reported represent the mean and standard deviation of three replicates.

TABLE 7

| Radial | Total intrusion | Modal pore | | BET surface |
|---|---|---|---|---|
| positions | volume, ml/g | diameter, nm | Porosity, % | area, m²/g |
| Centre | 2.21 ± 0.04 | 753.8 ± 2.5 | 79.6 ± 2.2 | 7.21 ± 0.02 |
| 6 mm | 2.19 ± 0.08 | 751.5 ± 2.3 | 77.1 ± 2.3 | 7.12 ± 0.01 |
| 12 mm | 2.18 ± 0.02 | 749.2 ± 2.2 | 76.3 ± 2.1 | 7.07 ± 0.04 |

### Example 19

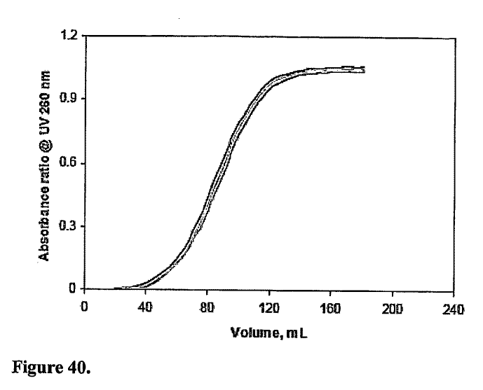

This example shows the dynamic binding capacity of certain monolithic polymers, prepared in according with certain embodiments. Rapid preparative-scale purification of plasmid vaccines often requires the use of stationary phases with high retention capacity maintained at high flow rates with low pressure drops. It is desirable to look at the dynamic binding capacity at different flow rates. Analysis was performed by loading the plasmid vaccine sample on the monolithic column at three different flow rates; 6 mL/min, 8 mL/min and 10 mL/min. After each loading, elution was performed with 1 M NaCl in the binding buffer. The results are as shown in FIG. 40 and Table 8. Since the normalized breakthrough curves overlap each other at the different flow rates, the binding capacity is not substantially affected by increasing flow rates. The capacity of the polymer is 0.59 g of pVR1020-PyMSP5/5, which gives a binding capacity of 14.2 mg/mL of support. As shown in Table 9, the binding capacity persisted after several applications of the polymer. FIG. 40 shows the dependency of the flow rate on the dynamic binding capacity. Conditions: flow rate, 6 mL/min, 8 mL/min and 10 mL/min; sample, 9.54 μg/mL pVR1020-PyMSP4/5 in a 25 mM Tris-HCl, 2 mM EDTA pH 8; detection, UV at 260 nm.

Table 8 shows data on pVR1020-PyMSP4/5 binding capacity analysis of poly(GMA-co-EDMA) monolithic polymer (modal pore size 750 nm) at different flow rates; 6 mL/min, 8 mL/min and 10 mL/min. Data reported represent the mean and standard deviation of three replicates (n=3).

TABLE 8

| Flow rates, | ΔP, | Capacity at 10% | Total binding |
|---|---|---|---|
| mL/min | MPa | breakthrough, mg/mL | capacity, mg/mL |
| 6.0 | 0.10 | 14.40 ± 0.21 | 17.81 ± 0.21 |
| 8.0 | 0.12 | 14.22 ± 0.34 | 17.64 ± 0.23 |
| 10.0 | 0.15 | 14.15 ± 0.32 | 17.32 ± 0.19 |

Table 9 shows the binding capacity of the amino-functionalised polymer with modal pore size 750 nm and ligand density 1.49 mmol/g measured at 10 mL/min in repeated loadings with column regeneration.

TABLE 9

| | Loading | | | | | | | | | |
|---|---|---|---|---|---|---|---|---|---|---|
| | 1 | 2 | 3 | 4 | 5 | 6 | 7 | 8 | 9 | 10 |
| Capacity at 10% | 100 | 97.5 | 95.5 | 89.5 | 81.3 | 75.4 | 70.1 | 65.2 | 60.8 | 55.3 |
| breakthrough, | | | | | | | | | | |
| % of max. | | | | | | | | | | |
| Total binding | 100 | 100 | 100 | 96.6 | 90.5 | 86.8 | 82.2 | 74.5 | 70.8 | 63.9 |
| capacity, % of | | | | | | | | | | |
| max. | | | | | | | | | | |

Column regenerated after the 10^{th} loading

| | Loading | | | | | | | | | |
|---|---|---|---|---|---|---|---|---|---|---|
| | 11 | 12 | 13 | 14 | 15 | 16 | 17 | 18 | 19 | 20 |
| Capacity at | 100 | 95.4 | 88.3 | 82.4 | 76.1 | 70.5 | 65.3 | 60.8 | 55.9 | 51.7 |
| 10% | | | | | | | | | | |
| breakthrough, | | | | | | | | | | |
| % of max. | | | | | | | | | | |
| Total binding | 100 | 100 | 97.5 | 93.5 | 87.1 | 84.2 | 76.8 | 70.9 | 66.3 | 59.4 |
| capacity, % | | | | | | | | | | |
| of max. | | | | | | | | | | |

Column regenerated after the 20^{th} loading

| | Loading | | | | | | | | | |
|---|---|---|---|---|---|---|---|---|---|---|
| | 21 | 22 | 23 | 24 | 25 | 26 | 27 | 28 | 29 | 30 |
| Capacity at | 100 | 100 | 92.7 | 89.5 | 83.6 | 78.3 | 72.4 | 66.5 | 59.8 | 53.7 |
| 10% | | | | | | | | | | |
| breakthrough, | | | | | | | | | | |
| % of max. | | | | | | | | | | |
| Total binding | 100 | 100 | 100 | 96.5 | 91.5 | 86.2 | 82.3 | 75.8 | 69.9 | 62.3 |
| capacity, % | | | | | | | | | | |
| of max. | | | | | | | | | | |

### Example 20

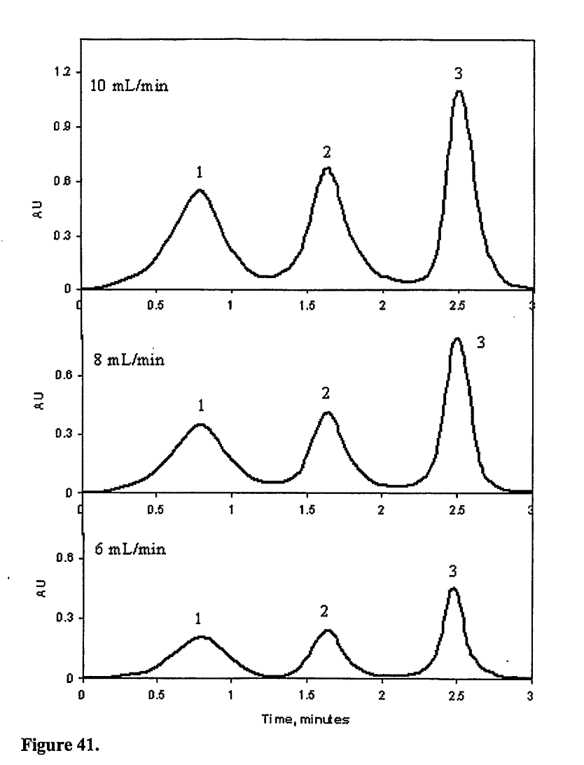

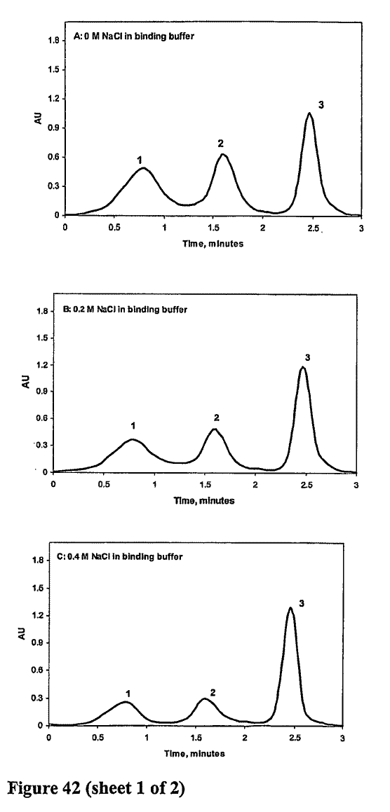

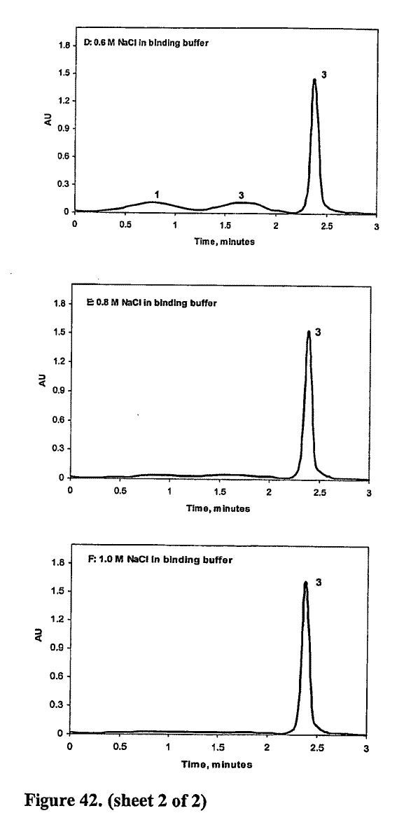

This example shows the isolation of a pDNA malaria vaccine from clarified bacteria lysate, in accordance with certain embodiments. In this example, the adsorbent support is used to purify clinical grade quality pDNA. FIG. 41 shows the resulting chromatograms for the isolation of the pDNA malaria vaccine from clarified lysate at the different flow rates; 6 mL/min, 8 mL/min and 10 mL/min. The chromatogram shows co-purification of protein and RNA resulting from the electrostatic interaction between the positively charged matrix and negatively charged RNA and protein molecules accompanying the target plasmid vaccine molecules in the clarified lysate. Bound RNA, proteins and the pDNA vaccine molecules were eluted respectively as first, second and third peaks on the chromatogram. Peak elution of the molecules is in order of increasing anionic charge density. Increasing the ionic strength of the binding buffer was adopted to minimize the adsorption of low charge density contaminants; RNA and protein (FIG. 42). Under this condition, impurities gradually flow through and the entire capacity of the polymer is fully utilised for the pDNA vaccine molecules adsorption. The final pDNA vaccine product obtained was a homogeneous supercoiled pDNA free from RNA and protein contaminations as shown by the EtBr agarose gel electrophoresis and SDS-PAGE pictures respectively in FIG. 43. FIG. 41 shows the effect of the flow rate on resolution for the isolation of pVR1020-PyMSP4/5 from E. coliDH5α-pVR1020-PyMSP4/5 clarified lysate at three different flow rates (6 mL/min, 8 mL/min and 10 mL/min). Mobile phase: 25 mM Tris-HCl, 2 mM EDTA, 0.2 M NaCl, pH 8 (buffer A) and 25 mM Tris-HCl, 2 mM EDTA, 2.0 M NaCl, pH 8 (buffer B). Gradient elution: 0-0.325 M for 102 s and Step elution, 0.325-0.75 M for 78 s. Peaks 1, 2 and 3 represent RNA, proteins and pVR1020-PyMSP4/5 vaccine fractions respectively. FIG. 42 shows the effect of ionic strength of binding buffer on retention and elution of pVR1020-PyMSP4/5 from E. coliDH5α-pVR1020-PyMSP4/5 clarified lysate. Chromatograms show reduction in the copurification of RNA and protein contaminants with increasing salt concentration. Stationary phase: amino-functionalised methacrylate monolith with active group density 1.49 mmol/g polymer and modal pore size 750 nm. Mobile phase: 25 mM Tris-HCl, 2 mM EDTA, ×NaCl, pH=8. Sample: 30 mL of clarified lysate. Flow rate; 10 mL/min. Gradient elution: 0-0.325 M for 102 sees and Step elution, 0.325-0.75 M for 78 secs. Peaks 1, 2 and 3 represent RNA, proteins and pVR1020-PyMSP4/5 vaccine fractions respectively. FIG. 43 shows: A) Results from EtBr agarose gel electrophoresis of pVR1020-PyMSP4/5 fraction from the final chromatographic purification with binding buffer 25 mM Tris-HCl, 2 mM EDTA, 1.0 M NaCl, pH=8. Analysis was performed using 1% agarose in TAE×1 buffer, 3 μg/ml EtBr at 66 V for 2 hours. Lane M is 1 kbp DNA ladder; lane 1 represents supercoiled pDNA fraction and lane 2 shows band for linear form obtained from BamHI cleavage at the sequence -G-G-A-T-C-C- of the final plasmid vaccine. Gel picture reveals no band for RNA or gDNA contaminants. B) SDS PAGE analysis to determine the protein content of the plasmid vaccine sample. Analysis was performed using BIORAD pre-cast poly-acrylamide gel in TSG (Tris-SDS-Glycine) buffer at 130 V for 90 mins and stained with a coomassie blue solution. Lane M represents a pre-stained protein marker; lanes 1 and 2 represent wells loaded with 28.4 μg/mL and 23.5 μg/mL of pVR1020-PyMSP4/5 vaccine samples. Picture reveals no protein bands.

### Example 21

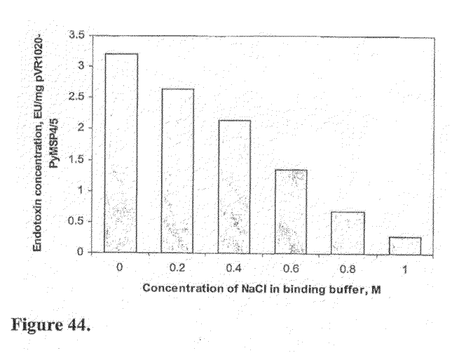

This example shows the endotoxin level estimation of pDNA malaria vaccine sample. Endotoxin levels of the different pDNA malaria vaccine samples obtained from binding buffers with different ionic strengths were determined to study the effect of salt concentration on the endotoxin concentration accompanying the plasmid vaccine. The vaccine samples were serially diluted with endotoxin-free water in combination with E-TOXATE (Sigma, Catalogue No. 9154) and compared to a serially diluted endotoxin standard (E. coli 0.55:B5 lipopolysaccharide) with 10000-20000 endotoxin units (EU) per vial. The analysis shows a gradual decrease in endotoxin level from 3.21-0.28 EU/mg pDNA vaccine with increasing salt concentration in the binding buffer from 0-1.0 M respectively (FIG. 44). Endotoxins present in E. coli are primarily lipopolysaccharide complex units enclosed in its outer envelope. The presence of high salt concentrations in the binding buffer may cause an osmotic shrinkage via the primary hydrophobic sites for larger molecular size endotoxin units, thereby decreasing molecular size of the lipopolysaccharide complexes. It is believed that this makes the samples more easily flow through the monolithic polymer, prepared in accordance with certain embodiments, with minimal interaction; thus causing a decrease in endotoxin level accompanying the pDNA vaccine fraction. Also, the exposed hydrophobic groups on the lipopolysaccharide complexes cause weaker or no interaction with the polymer even at lower ionic strengths of the binding buffer, hence can easily be washed off. FIG. 44 shows the effect of NaCl concentration on pVR1020-PyMSP4/5 vaccine endotoxin level. The analysis shows a gradual decrease in endotoxin level from 3.21 EU/mg pDNA to 0.28 EU/mg pVR1020-PyMSP4/5 for 0 M and 1.0 M NaCl respectively.

### Example 22

This example shows the quality and purity analysis of the plasmid vaccine product produced using certain embodiments. The purified pVR1020-PyMSP4/5 malaria vaccine product was sterile filtered to meet release or administration specifications. The purified malaria vaccine product specifications was adjudged as in Table 10 to be in conformity with defined values of regulatory agencies for key contaminants such as proteins, RNA, gDNA, endotoxins and non-supercoiled pDNA (open circular or linear). The most commonly used analytical technique for examining nucleic acid purity and quality is EtBr agarose gel electrophoresis. This technique is based on the different migration rates (from negative terminal to the positive terminal) of the nucleic acid components in the vaccine sample. The different components can be visualised, photographed, identified and quantified. Other methods like qPCR, HPLC ribose assay, BCA assay (or Bradford assay and SDS page) and LAL assay can be used to determine gDNA, RNA, proteins and endotoxin levels respectively. Table 10 shows the properties of the purified pVR 020-PyMSP4/5 malaria vaccine product. Data reported represent the mean and standard deviation of three replicates (n=3).

TABLE 10

| | Regulatory | | |
|---|---|---|---|
| | standards for | Properties of | |
| | pDNA | purified plasmid | |
| | vaccine | malaria vaccine | |
| Components | delivery [23] | sample | Remarks |
| % of | >90% | 92.5 ± 1.3 | Conforms to |
| supercoiled | | (band densitometric | regulatory standards |
| pDNA | | analysis) | |
| % of E. coli | <1% | Undetected by EtBr | Conforms to |
| gDNA | | agarose gel | regulatory standards. |
| | | electrophoresis | Quantitative |
| | | with sensitivity | techniques could be |
| | | <0.01% | employed to estimate |
| | | | exact concentrations. |
| % RNA | <0.1% | Undetected by EtBr | Conforms to |
| | | agarose gel | regulatory standards. |
| | | electrophoresis | Quantitative |
| | | with sensitivity | techniques could be |
| | | <0.01% | employed to estimate |
| | | | exact concentrations. |
| Endotoxin | <0.5 EU/mg | 0.28 ± 0.11 EU/mg | Conforms to |
| | pDNA | pDNA vaccine (by | regulatory standards |
| | | LAL assay) | |
| % Proteins | <1% | 0.26 ± 0.08% by | Conforms to |
| | | Bradford assay, | regulatory standards |
| | | protein content | |
| | | undetected by SDS | |
| | | page | |

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Each mentioned in this specification are herein incorporated by reference in their entirety. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-61. (canceled)

62. A support apparatus comprising:
(a) a polymer of one or more methacrylate monomers, wherein said one or more monomers comprises one or more functional groups; and
(b) pores having an average diameter between about 100 nm and about 2000 nm.

63. The apparatus according to claim 62, wherein said pores have an average diameter between about 320 and about 1150 nm, or between about 150 nm and about 1850 nm.

64. The apparatus according to claim 62, wherein said pores present in the apparatus having a diameter less or greater than the defined range is less than about 5% of the differential pore volume of said apparatus.

65. The apparatus according to claim 64, wherein said monomer comprising one or more functional groups is selected from a group consisting of: butylmethacrylates, glycol methacrylates, methyl 2-methylprop-2-enoate, oxiran-2-ylmethyl 2-methylprop-2-enoate, ethyl methylacrylates, oxydiethylene methacrylates, oxydiethylene methacrylate, N-(4-tolyl)glycine-glycidyl methacrylate, methyl 2-methylprop-2-enoate, octadecyl 2-methylprop-2-enoate, oxiran-2-ylmethyl 2-methylprop-2-enoate, glycidyl methacrylate (GMA), or combinations thereof.

66. The apparatus according to claim 62, wherein said functional group is selected from a group consisting of: an anion-exchange ligand, cation-exchange ligand, hydrophobic interaction ligand, ion-pairing ligand, affinity ligand, or combinations thereof.

67. The apparatus according to claim 66, wherein said anion-exchange ligand is selected from a group consisting of: quaternary ammonium cations, primary, secondary or tertiary amines, and diethylethanolamines such as 2-chloro-N,N-diethylethylamine hydrochloride (DEAE-Cl), or combinations thereof.

68. The apparatus according to claim 62, wherein said pores are unimodal.

69. The apparatus according to claim 62, wherein said pores are either monodispered or substantially monodispersed.

70. The apparatus according to claim 62, wherein said pores are interconnected.

71. A method of manufacturing an apparatus, comprising:
(a) polymerizing one or more monomers at a temperature between about 50° C. and 70° C.;
(b) adding one or more porogens; and
(c) optionally adding one or more initiators.

72. The method according to claim 71, further comprising preheating a mixture of said porogen and said initiator prior to combing said mixture to the polymerization.

73. The method according to claim 72, further comprising minimizing heat buildup.

74. The method according to claim 71, further comprising preheating and mixing monomer feeds to just below synthesis temperature before adding to synthesis chamber.

75. A method of purifying or separating or filtrating or isolating a target molecule using the apparatus of claim 62, comprising:
(a) providing the apparatus, comprising a polymer of one or more methacrylate monomers, wherein said one or more monomers comprises one or more functional groups; and pores having an average diameter between about 150 nm and about 1850 nm.
(b) applying a sample to the apparatus;
(c) eluting said target molecule from the apparatus with an elution buffer; and
(d) optionally analyzing said target molecule.

76. The method according to claim 75, wherein said target molecule is a biomolecule.

77. The method according to claim 76, wherein said elution buffer has an ionic strength less than the ionic strength of a running buffer.

78. A kit comprising an apparatus, wherein said apparatus comprises a polymer of one or more methacrylate monomers, wherein said one or more monomers comprises one or more functional groups; and pores having an average diameter between about 100 run and about 2000 nm.

79. The kit according to claim 78, further comprising an elution buffer, a washing buffer and/or a running buffer.

80. A method of reusing or regenerating the apparatus prepared by claim 63.

81. A method of reducing the number of unit operations in a post-clarification plasmid downstream processing, comprising providing the apparatus according to claim 63.
